(19) United States
(12) Patent Application Publication
(10) Pub. No.: US 2017/0091779 A1
(43) Pub. Date: Mar. 30, 2017

(54) CONTEXT-AWARE SUPPORT

(71) Applicant: Microsoft Technology Licensing, LLC, Redmond, WA (US)

(72) Inventors: Warren Johnson, Sammamish, WA (US); Sanjeev Balarajan, Bellevue, WA (US); He Liu, Sammamish, WA (US); Andy Siow, Bellevue, WA (US); Matthew Lopez, Seattle, WA (US); Masroor Syed Hussain, Mill Creek, WA (US); Brian Van Doren, Redmond, WA (US)

(21) Appl. No.: 14/870,795

(22) Filed: Sep. 30, 2015

(51) Int. Cl. G06Q 30/00; G06Q 10/06

(52) U.S. Cl. CPC G06Q 30/016; G06Q 10/063114

(57) ABSTRACT

Technologies for enabling real-time support for requests (e.g., onboarding requests, support requests, managing requests, troubleshooting requests, etc.) based at least in part on contextual data are described. The technologies described can receive a request associated with a product and/or a service and determine contextual data associated with the request. The contextual data can define a status of an application associated with the product and/or the service. Additionally, the technologies described can include determining support providers for supporting the request based partly on the contextual data and generating task data associated with the request. The task data can include the contextual data. The technologies described can further include sending the task data to devices corresponding to the support providers, determining that an individual support provider of the support providers accepts the request, and causing a display of a graphical element indicating that the individual support provider accepts the request.

### BACKGROUND

When encountering issues with products and services, it is common for consumers to contact a service center for assistance. Generally, consumers can submit a request for assistance by the use of a number of technologies, some of which can include the use of an email, phone call, instant message, etc. In some systems, consumer requests are forwarded to a queue. Customer service representatives can access and service the consumer requests in the queue on a first-come, first-served basis.

In many circumstances, the first customer service representative who accesses the consumer request cannot answer the consumer's question or provide the correct type of help that the consumer requested. Sometimes, the consumer can be directed to a number of other customer service representatives before the question is answered or the correct type of help is provided. Re-direction can be time consuming for both consumers and customer service representatives and, in many circumstances, does not provide a resolution. As a result, consumers are often frustrated with products, services, and/or customer service offered for the products and/or services.

### SUMMARY

Technologies for enabling real-time support for requests (e.g., onboarding requests, support requests, managing requests, troubleshooting requests, etc.) based at least in part on contextual data are described. The technologies described can receive a request associated with a product and/or a service and determine contextual data associated with the request. The contextual data can define a status of an application associated with the product and/or the service. Additionally, the technologies described can include determining support providers for supporting the request based partly on the contextual data and generating task data associated with the request. The task data can include the contextual data. The technologies described can further include sending the task data to devices corresponding to the support providers, determining that an individual support provider of the support providers accepts the request, and causing a display of a graphical element indicating that the individual support provider accepts the request.

It should be appreciated that the above-described subject matter can be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing several example components of a system for enabling real-time support of a request based at least in part on contextual data.

FIG. 2 is a flow diagram illustrating aspects of a method for enabling real-time support of a request based at least in part on contextual data.

FIG. 3 is a flow diagram illustrating aspects of a method for determining one or more support providers for supporting a request and causing a graphical element corresponding to the request to be presented on devices corresponding to the one or more support providers.

FIG. 4 is a flow diagram illustrating aspects of a method for enabling real-time support of a request based at least in part on contextual data.

FIG. 5A is a block diagram showing an example user interface presenting a graphical element corresponding to a control for providing users with functionality to submit a request.

FIG. 5B is a block diagram showing an example user interface presenting a graphical element corresponding to a control for notifying users that a request was received and providing users with functionality to join a shared meeting.

FIG. 5C is a block diagram showing an example user interface presenting a graphical element corresponding to a mechanism for providing users with functionality to provide feedback associated with the support experience.

FIG. 6 is a flow diagram illustrating aspects of a method for presenting user information corresponding to a request to a support provider based at least in part on the support provider accepting the request.

FIG. 7A is a block diagram showing an example user interface presenting a graphical representation of a task list including one or more graphical elements corresponding to tasks.

FIG. 7B is a block diagram showing an example user interface presenting user information corresponding to a request.

FIG. 8 is a computer architecture diagram illustrating an illustrative computer hardware and software architecture for a computing system capable of implementing aspects of the techniques and technologies presented herein.

FIG. 9 is a diagram illustrating a distributed computing environment capable of implementing aspects of the techniques and technologies presented herein.

FIG. 10 is a computer architecture diagram illustrating a computing device architecture for a computing device capable of implementing aspects of the techniques and technologies presented herein.

### DETAILED DESCRIPTION

The following detailed description is directed to technologies for enabling real-time support for requests based at least in part on contextual data. For illustrative purposes, support providers can include entities competent to provide support services associated with products, services, etc. Support providers can be internal to a service provider associated with a support application. For instance, support providers can be employees who provide support for the service provider. Or, support providers can be external to the service provider. For example, support providers can be entities that contract with the service provider to provide support services but are not directly employed by the service provider. In some examples, support providers can be third-party entities that include third-party vendors, partners, etc. providing support services (e.g., GODADDY®, APPRIVER®, etc.), freelance support providers providing support services (e.g., ODESK®, ELANCE®, etc.), etc. In at least one example, the third-party entities can have one or more sub-support providers who provide support for various service providers on behalf of the third-party entities. For instance, the one or more sub-support providers can be employees or contractors associated with the third-party entities.

Further, for illustrative purposes, a request can include a submission for assistance, instructions, or other types of information related to a product, a service, etc. For instance, a request can include an onboarding request. An onboarding request can be a request for assistance with getting started with a new product, service, etc. A request can include a support request. A support request can be a request for assistance associated with a product, service, etc. A request can be a managing request. A managing request can be a request for assistance with managing a product, a service, etc., such as billing, subscription, permissions, etc. A request can be a troubleshooting request. A troubleshooting request can be a request for assistance with a technical issue associated with a product, a service, etc.

Technologies for enabling real-time support for requests based at least in part on contextual data are described. The technologies described can receive a request associated with a product and/or a service and determine contextual data associated with the request. The contextual data can define a status of an application associated with the product and/or the service. Additionally, the technologies described can include determining support providers for supporting the request based partly on the contextual data and generating task data associated with the request. The task data can include the contextual data. The technologies described can further include causing a display of a graphical element corresponding to the task data to be presented on user interfaces of devices corresponding to the support providers and determining that an individual support provider of the support providers accepts the request based at least in part on receiving acknowledgement of the task data from a device corresponding to the individual support provider. In at least one example, the acknowledgement can be associated with acknowledgement data indicating that an acknowledgment of the task data.

The technologies described herein can be useful for improving the customer support experience for users by enabling support providers to provide real-time support for requests. For instance, various support providers from around the world can access a server associated with a support application service provider. Based at least in part on the individual support providers accessing the support application via the server, the individual support providers can receive and/or access individualized task lists that include one or more tasks. Each of the one or more tasks can correspond to a request, as described above. An individual support provider can accept a task on its task list thereby causing that task to be removed from task lists associated with the other individual support providers. Based at least in part on accepting the task, the individual support provider can interact with the user who submitted the task and provide support services for resolving the request.

In a non-limiting example, a first user can be a small business owner based in Seattle, Wash. The first user can purchase a new product and while transitioning her small business from the old product to the new product, the first user can become confused on how to migrate the small business's current domains. The first user can actuate a control on a user interface associated with the new product. The control can be associated with a support application. Based at least in part on actuating the control on the user interface, the first user can receive a notification indicating that domain migration will begin momentarily.

In the non-limiting example, a second user can be executing the support application on his or her device (e.g., a freelancing support provider). The second user can indicate that he or she is available. For illustrative purposes, the second user can be available such that the second user is signed onto the support application via a support provider profile. The second user can actively monitor a task list associated with the support application. The second user can receive a notification on the device associated with the second user. The notification can alert the second user that a task has been added to the second user's task list. The task list can include one or more tasks that correspond to requests that have not yet been serviced. The second user can determine, from the task list, a user associated with each task and the contextual data corresponding to each task. In some examples, the second user can access additional contextual data to determine additional details about the particular issue that prompted the request. The second user can accept the request and start the domain migration for the first user. Responsive to the second user accepting the request, the first user can receive a notification confirming receipt of the request. In some examples, the notification can include a mechanism for creating a shared meeting space for the first user and the second user in addition to the response confirming receipt of the request.

Based at least in part on the second user resolving the request (or, in some examples, not resolving the request), the first user can access a mechanism associated with a user interface of the support application for receiving feedback data from the first user about at least one of the second user or resolution of the request. The support application can leverage the feedback data and/or performance data for rating individual support providers (e.g., the second user) and/or all support providers with support provider profiles associated with the support application and/or determining the satisfaction of individual support application users (e.g., the first user).

Generally, the technologies described herein can be useful for improving the customer support experience for users. That is, the technologies described herein can improve the customer support experience by reducing time that lapses between users sending requests and support providers responding to the requests and/or resolving issues associated with the requests. In some examples, the technologies described herein can conserve computing resources and reduce network bandwidth usage by streamlining requests to support providers who are available and capable of resolving the requests in near real-time based at least in part on contextual data associated with the requests.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations, including hand-held devices, multiprocessor systems, microprocessor-based or programmable consumer electronics, minicomputers, mainframe computers, and the like.

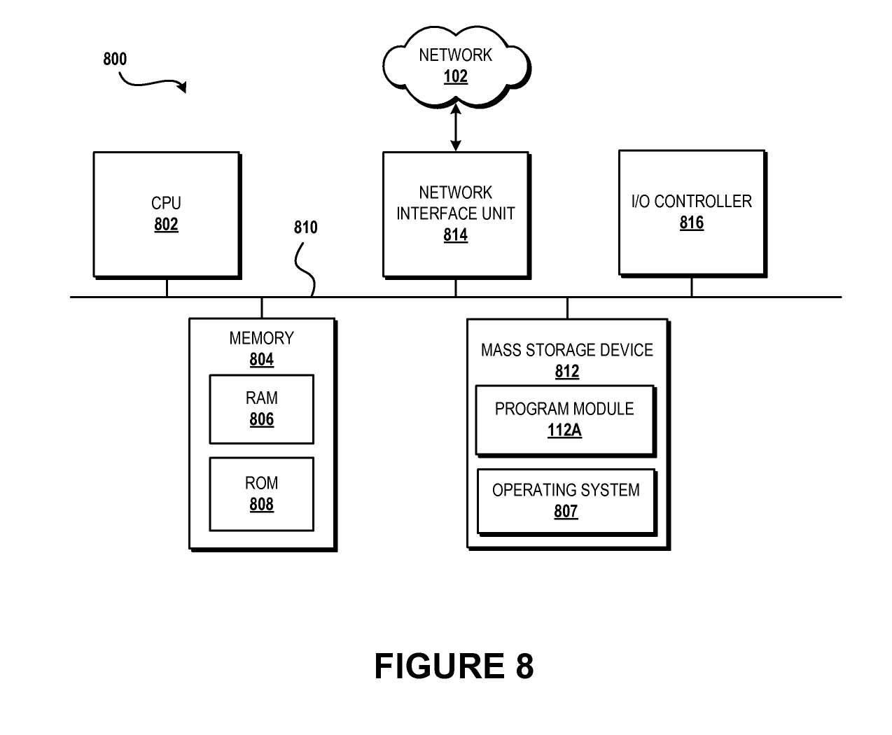

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for enabling real-time support for requests based at least in part on contextual data. As will be described in more detail below with respect to FIGS. 8-10, there are a number of applications and services that can embody the functionality and techniques described herein.

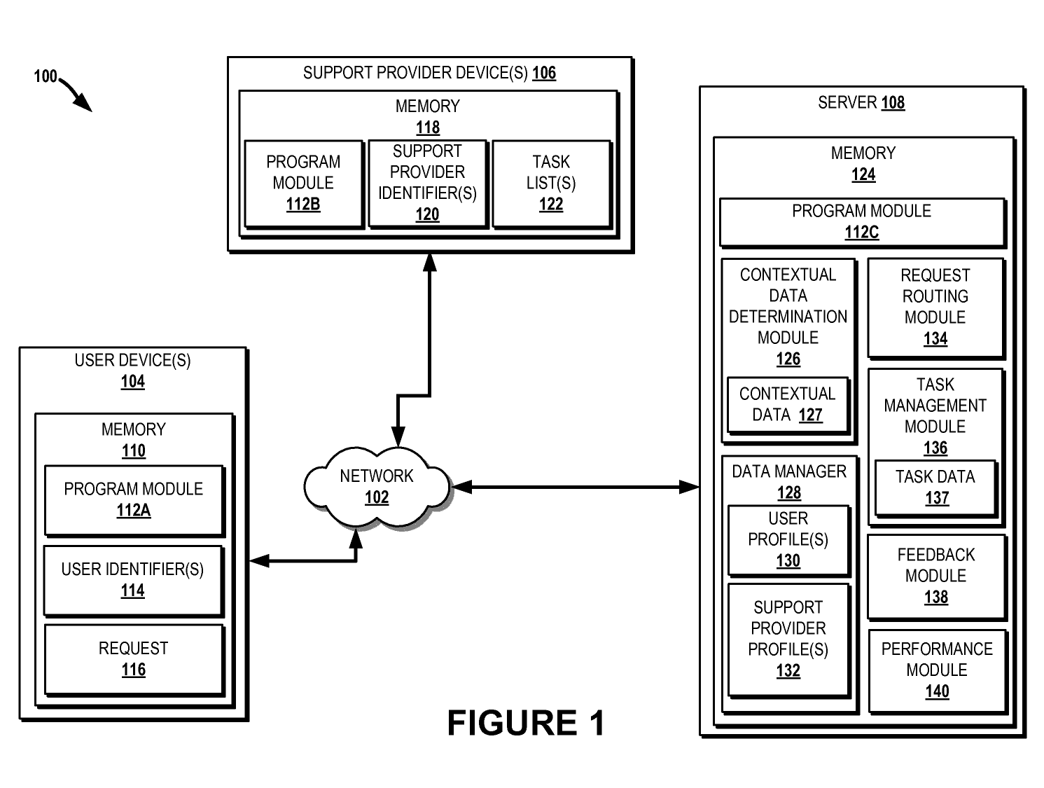

FIG. 1 is a block diagram showing several example components of a system 100 for providing real-time support for requests based at least in part on contextual data. As shown in FIG. 1, system 100 can include at least a network 102, one or more computing devices associated with users (e.g., user device(s) 104), one or more computing devices associated with support providers (e.g., support provider device(s) 106), and a server 108. Additional computing devices (not shown) can communicatively couple to the network 102. The user device(s) 104 and/or the support provider device(s) 106 can represent computing devices that can run applications. In at least one example, the user device(s) 104 and/or the support provider device(s) 106 can be user devices, for example, such as a laptop computer, a desktop computer, a smartphone, a tablet computing device or any other computing device, communicatively connected to the support provider device(s) 106 and/or the user device(s) 104, respectively, and the server 108 through one or more local and/or wide area networks, such as the network 102. In other examples, the user device(s) 104 and/or the support provider device(s) 106 can be in the form of a server computer or a number of server computers. It should be appreciated that many more network connections can be utilized than are illustrated in FIG. 1.

The user device(s) 104 can include a local memory 110 that can include one or more modules and data structures, such as a program module 112A. The one or more modules and data structures can be in the form of stand-alone applications, productivity applications, an operating system component or any other application or software module having features that facilitate interactions between the user device(s) 104, the support provider device(s) 106, and/or the server 108. In at least one example, the program module 112A can be associated with a support application. Additional modules and components of the user device(s) 104 are explained below and shown in FIG. 8.

The user device(s) 104 can be associated with user identifier(s) 114 for identifying a user of the user device(s) 104. The program module 112A can be configured to provide mechanisms for the user to submit a request 116 associated with a product, a service, etc., and receive communications facilitating support from a support provider in real-time. For illustrative purposes, real-time refers to a time within a threshold time of a timestamp associated with when a user submits a request 116. As described below, a user can submit a request 116 by actuating a control on a user interface, requesting help via voice input, etc. The one or more modules and data structures can be configured to manage interactions between the user device(s) 104, the support provider device(s) 106, and/or the server 108.

As will be explained below, the program module 112A can be configured to send and/or receive communications from the support provider device(s) 106 and/or the server 108. In at least one example, a user can submit a request 116 based at least in part on the user actuating a control presented on a user interface associated with a product, a service, etc. The control can be associated with a support application (e.g., an application corresponding to program module 112A) or with the particular product, service, etc. In other examples, a user can provide alternative inputs, such as voice input, gaze input, etc. to submit requests 116. As described above, requests 116 can include onboarding requests, support requests, managing requests, troubleshooting requests, requests for directions, etc. In at least one example, based at least in part on determining that a user submitted a request 116, the program module 112A can send requests 116 to the server 108 and/or the support provider device(s) 106 via the network 102.

Additionally and/or alternatively, the program module 112A can receive responses from the server 108 and/or the support provider device(s) 106. The responses can include notifications confirming receipt (e.g., acknowledgement) of requests 116 and/or requesting additional information from users, mechanisms for creating shared meeting spaces for users associated with user devices (e.g., user device(s) 104) and support providers associated with support provider devices (e.g., support provider device(s) 106), mechanisms for receiving feedback from users associated with user devices (e.g., user device(s) 104), etc. The program module 112A can be configured to cause graphical elements corresponding to the controls, mechanisms (e.g., shared meeting space invites, feedback surveys, etc.), notifications, etc., described above, to be presented on a user interface of the user device(s) 104. In some examples, the notifications can include a display of a graphical element, an audio signal, a message, a status change of at least one component of a computing device, etc.

The support provider device(s) 106 can include a local memory 118 that can include one or more modules and data structures, such as a program module 112B. The one or more modules and data structures can be in the form of stand-alone applications, productivity applications, an operating system component or any other application or software module having features that facilitate interactions between the user device(s) 104, the support provider device(s) 106, and/or the server 108. In at least one example, program module 112B can be associated with the same support application as program module 112A.

The support provider device(s) 106 can be associated with support provider identifier(s) 120 for identifying support providers corresponding to individual support provider device(s) 106. The program module 112B can be configured to provide mechanisms for receiving communications associated with requests 116, causing a graphical elements corresponding to task data representative of the requests 116 to be presented on the support provider device(s) 106 in association with task list(s) 122, and enabling a support provider to accept the request 116 in real-time. The one or more modules and data structures can be configured to manage interactions between the user device(s) 104, the support provider device(s) 106, and/or the server 108.

The program module 112B can be configured to receive communications associated with requests 116. In some examples, the communications can include task data corresponding to requests 116. The task data can be associated with task list(s) 122. In at least one example, task list(s) 122 can be data storage components for temporarily storing task data. The program module 112B can cause a graphical representation of a task list 122 to be presented on a user interface via a display of the support provider device(s) 106. The task list 122 can be graphically represented by graphical elements corresponding to task data.

The user interface can be configured to provide functionality for the support provider to interact with individual of the graphical elements of the task list 122 to gain access to additional contextual data. For instance, a support provider can interact with the graphical elements via touch input, sound input, gaze input, etc. to access additional contextual data. Additionally, the user interface can be configured to provide functionality for the support provider to accept individual tasks on the task list 122. For instance, a support provider can accept individual tasks via touch input, sound input, gaze input, etc. In at least one example, the input can generate acknowledgement data indicating an acknowledgement of the task (e.g., 702A, 702B).

The task list(s) 122 can be associated with the support provider identifier(s) 120 and can each include one or more tasks corresponding to individual requests 116 and contextual data corresponding to each task. The task list 122 corresponding to each support provider can be unique to that support provider and can be different from task lists 122 corresponding to other support providers associated with the support application. In some examples, task list(s) 122 can be sent from the server 108 to the support provider device(s) 106. In other examples, communications can be sent from the server 108 to the support provider device(s) 106 for updating a task list 122 stored on a support provider device 106. In at least one example, the tasks can be arranged based on a timestamp associated with a time the user submits a request 116. Each of the tasks in the task list 122 can correspond to a currently outstanding request 116 has not yet been accepted by a support provider. As described above, each task on the task list 122 can be associated with task data. The task data can include tasks, contextual data corresponding to the tasks, data associated with the users who submitted the requests 116 corresponding to the tasks (e.g., name, contact information, etc.), etc. Based at least in part on determining that a support provider accepts a task, the task can be removed from task lists 122 associated with all other support providers who received task data associated with the request 116.

The program module 112B can be configured to send responses to the user device(s) 104 and/or the server 108. The responses can include notifications that a task data 137 has been received and/or acknowledged, a request 116 has been accepted, mechanisms for creating shared meeting spaces for users and support providers, etc. In at least one example, the notifications can include a display of a graphical element, an audio signal, a message, a status change of at least one component of a computing device, etc. In some examples, the responses can prompt the user for additional information associated with the request 116.

The server 108 can be in the form of a server computer or a number of server computers configured to send and receive communications from the user device(s) 104 and/or the support provider device(s) 106. The server 108 can include a local memory 124 that can include one or more modules and data structures, such as a program module 112C, a contextual data determination module 126, a data manager 128 that includes user profile(s) 130 and support provider profile(s) 132, a request routing module 134, a task management module 136, a feedback module 138, and a performance module 140. The one or more modules and data structures can be configured to manage interactions between the user device(s) 104, the support provider device(s) 106, and/or the server 108. In at least one example, the server 108 can provide an interface configured to receive data associated with requests, contextual data, acknowledgement data, feedback data, performance data, data associated with users and/or support providers, etc. In additional and/or alternative examples, the server can provide an interface configured to transmit task data including contextual data, acknowledgement data, feedback data, performance data, etc. The one or more modules and data structures can be in the form of stand-alone applications, productivity applications, an operating system component or any other application or software module having features that facilitate interactions between the user device(s) 104, the support provider device(s) 106, and/or the server 108. In at least one example, the program module 112C, the contextual data determination module 126, the data manager 128, the request routing module 134, the task management module 136, the feedback module 138, and the performance module 140 can be associated with the same support application as program module 112A and program module 112B.

The program module 112C can be configured to facilitate communications between the user device(s) 104 and the support provider device(s) 106. The program module 112C can receive requests 116 from the user device(s) 104. The program module 112C can be configured to receive responses from the support provider device(s) 106 and can be configured to send the responses to the user device(s) 104. As described above, the responses can include notifications that a request 116 has been acknowledged and/or accepted, mechanisms for creating shared meeting spaces for users and support providers, requests for additional information associated with the request 116, etc.

The contextual data determination module 126 can be configured to receive, access, and/or generate contextual data 127. Contextual data 127 can be received and/or accessed from any number of resources and contextual data 127 can be in any format. Contextual data 127 can enable support providers to access knowledge about requests 116 submitted by users. Contextual data 127 can be data that can define a status of an application associated with a product, a service, etc., a status of an interface associated with a product, a service, etc., etc. For illustrative purposes, applications are programs created by programmers to fulfill specific tasks. Non-limiting examples of applications include batch files, scripts (e.g., in a user device or a web service), etc. For example, applications can provide utility and/or productivity functionality, entertainment services, educational services, consumer management services, etc. to users of devices. For illustrative purposes, an application can include a web browser application, a wizard application, a mailbox application, a messaging services application, a social networking services application, a consumer management services application, etc. In at least one example, contextual data 127 can be obtained by an analysis of an application, an interface associated with a product, service, etc. In some examples, contextual data determination module 126 can determine contextual data 127, as described below. In other examples, the user device(s) 104 and/or third-party service providers can determine contextual data 127 and send the contextual data 127 to the contextual data determination module 126.

In a non-limiting example, an application can be a wizard application. The wizard application can guide users through several steps to complete tasks. In some examples, the wizard application can help users configure or install a software application. In other examples, the wizard application can help users complete other tasks such as configuring a product or managing a transaction. An analysis of an application, such as a wizard application, allows techniques described herein to generate contextual data 127 defining steps that the user has taken towards completing a task, steps that a user has had trouble with in the past, a status of a current step, and other status information.

In another non-limiting example, an application can be a web browser. The web browser application can retrieve, present, and traverse information resources via the Internet. Examples of web browser applications include INTERNET EXPLORER®, GOOGLE CHROME®, SAFARI®, etc. Information resources can include web pages, images, videos, other data items, etc. that are identified by Uniform Resource Identifiers (URI/URL). In some examples, users can utilize the web browser application to access various web pages, etc. The web browser application can collect data associated with web pages users visit to determine histories of web pages visited by users, frequencies associated with individual of the web pages visited by the users, numbers of times users visit individual of the web pages, etc. An analysis of an application, such as a web browser application, allows techniques described herein to generate contextual data 127 defining a current web page that a user is viewing, a history of web pages a user has accessed, a frequency that a user has visited individual of the web pages, a number of times a user has visited individual of the web pages, and other status information.

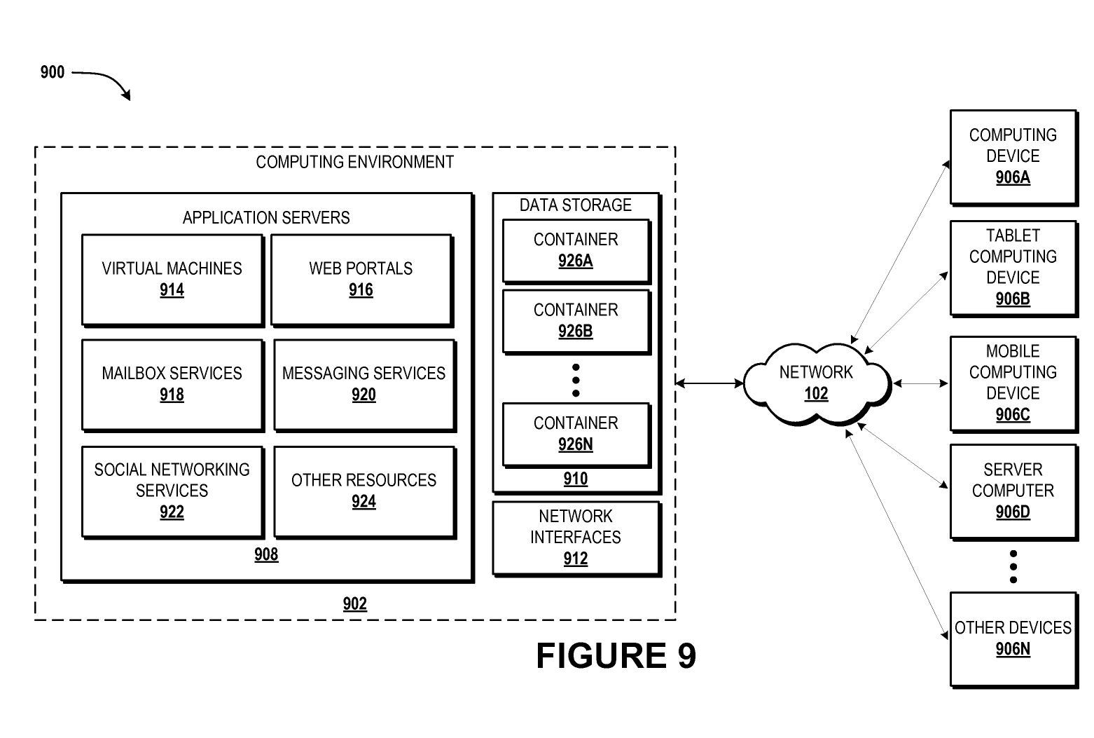

In yet another non-limiting example, an application can be a mail services application or a messaging services application. As described below in FIG. 9, a mailbox application can provide electronic mail (“email”) services, personal information management (“PIM”) services including, but not limited to, calendar services, contact management services, collaboration services, and/or other services. A messaging services application can provide instant messaging services, chat services, forum services, and/or other communication services. Users can exchange electronic communications with other users using the mail services application and/or messaging services application. An analysis of an application, such as a mail services application and/or a messaging services application, allows techniques described herein to generate contextual data 127 defining a status of a mail services application and/or messaging services application, a subject of an electronic communication sent and/or received by a mail services application and/or a messaging services application, etc. In some examples, the contextual data determination module 126 can leverage semantic parsing to determine contextual data 127 from text included in text included in electronic communications sent and/or received by a mail services application and/or a messaging services application, etc.

In another non-limiting example, an application can be a social networking services application. As described below in FIG. 9, the social networking services application can provide various social networking services including, but not limited to, services for sharing or posting status updates, instant messages, links, photos, videos, and/or other information; services for commenting or displaying interest in articles, products, blogs, or other resources, and/or other services. Additionally and/or alternatively, a social networking services application also provide commenting, blogging, and/or micro blogging services, etc. An analysis of an application, such as a social networking services application, allows techniques described herein to generate contextual data 127 defining a status of a social networking services application, an action associated with the social networking services application, etc. In some examples, the contextual data determination module 126 can leverage semantic parsing to determine contextual data 127 from text included in status update postings, comments on articles, products, blogs, etc., etc.

In yet another non-limiting example, an application can be a consumer management services application. A consumer management services application can provide various consumer management services including, but not limited to, recording transactions, generating analytics (e.g., numerical or tabular data) associated with the transactions, creating graphical elements corresponding to the analytics for presenting to users, etc. to view and analyze consumer behavior. In at least one example, the consumer management application can generate a graphical element that corresponds to a funnel that visually identifies how users move through a series of transactional steps associated with a transaction and where users abandon a transaction. An analysis of an application, such as a consumer management services application, allows techniques described herein to generate contextual data 127 defining a status of a consumer management services application, a status of funnel, a status of a transactional step associated with the funnel, etc.

In at least some examples, the contextual data determination module 126 can analyze an interface associated with an application to determine contextual data 127. In some examples, an analysis of an interface associated with an application allows techniques described herein to generate contextual data 127 defining a status of the interface, a status of a region of the interface, etc. In other examples, the contextual data 127 can define a region of an interface that a user spent an amount of time that exceeds a threshold amount of time, how much time a user spent interacting with a region of an interface, a most frequently visited region of an interface; a region of an interface that a user interacted with prior to submitting a request 116, etc.

In at least one example, the contextual data determination module 126 can prompt a user for additional contextual data 127. For instance, the contextual data determination module 126 can cause one or more questions (e.g., multiple choice questions, Likert questions, etc.) to be presented to the user and/or can cause a freeform text box to be presented to the user. The contextual data determination module 126 can leverage semantic parsing to determine additional or alternative contextual data 127 from text input into the freeform text box.

The data manager 128 can be configured to receive and/or access data associated with users corresponding to user devices (e.g., user device(s) 104) and/or support provider data associated with support providers corresponding to support provider devices (e.g., support provider device(s) 106). Individual users can be associated with user profile(s) 130. Individual user profile(s) 130 can be associated with unique identifiers (e.g., user identifier(s) 114) and can be stored in the data manager 128. The data manager 128 can receive and/or access data associated with the individual users (e.g., user data) based at least in part on data input by the individual users, third-party service providers, etc. The data manager 128 can receive and/or access the data associated with the individual users when the individual users set up user profile(s) 130, responsive to requests for data, etc. The data associated with the individual users can be mapped to corresponding user profile(s) 130.

Data associated with the individual users (i.e., user data) can include an identity of the user. An identity of an entity can include a name of entity, a type of entity (e.g., business, individual, etc.), etc. Data associated with the individual users can include a location of the user, a language of the user, a number of employees employed by a user, etc. Additionally and/or alternatively, data associated with the individual users can include a type of a subscription associated with the user as determined by the level of support services the user subscribes to, a length of the subscription associated with the user as determined by how long the user has subscribed to the support services, etc. Examples of data associated with the individual users can include data identifying a list of preferred support providers for supporting requests 116 submitted from the users, data identifying a preferred skill set associated with support providers supporting requests submitted from the users, etc. Additional and/or alternative examples of data associated with the individual users can further include a history of requests 116 associated with the user, feedback provided by the user, etc. The history of requests 116 can include contextual data 127 associated with previous requests 116, a frequency of previous requests 116, etc.

Individual support providers can be associated with support provider profile(s) 132. Individual support provider profile(s) 132 can be associated with unique identifiers (e.g., support provider identifier(s) 120) and can be stored in the data manager 128. The data manager 128 can receive and/or access data associated with the individual support providers (e.g., support provider data) based at least in part on data input by the individual support providers, third-party service providers, etc. The data manager 128 can receive and/or access the data associated with the individual support providers when the individual support providers set up support provider profile(s) 132, responsive to requests for data, etc. Data associated with individual support providers can include availability data indicating whether a support provider is signed onto the support application via a corresponding support provider profile 132. In at least one example, data associated with individual support providers (e.g., support provider data) can include an expertise associated with the support provider as determined by the requests a support provider is qualified to resolve, an authorization associated with the support provider as determined by the requests a support provider is permitted to resolve, etc. In some examples, the expertise associated with the support provider and/or the authorization associated with the support provider can be determined by the support provider. In other examples, the expertise associated with the support provider and/or the authorization associated with the support provider can be determined based on feedback data, performance data, etc. In additional and/or alternative examples, data associated with individual support providers can include a language of the support provider, a geographic location of the support provider, feedback associated with the support provider, a rating associated with the support provider, etc.

Additionally and/or alternatively, data associated with individual support providers can include a quota of requests associated with the support provider, a minimum number of requests associated with the support provider, a compensation structure associated with the support provider, etc. For instance, the support provider data can indicate a limit as to the number of requests 116 a support provider can accept in a predetermined period of time (e.g., hour, day, week, month, etc.) (i.e., quota) and/or a minimum number of requests 116 that a support provider is required to accept in a predetermined period of time (e.g., hour, day, week, month, etc.) (i.e., threshold). In other examples, the support provider data can include data associated with a compensation structure to determine how much a support provider is paid per request 116 it accepts and/or resolves.

The request routing module 134 can be configured to determine one or more support providers for routing requests 116. The request routing module 134 can access user data and/or support provider data. Additionally, the request routing module 134 can access the requests 116 and/or contextual data 127, as described above. The request routing module 134 can compare the request 116, contextual data 127, and/or user data with the support provider data and, based at least in part on comparing the request 116, contextual data 127, and/or user data with the support provider data, can determine one or more support providers for supporting the request. In at least one example, the request routing module 134 can select one or more support providers for support the request 116 based at least in part on determining a correlation between the contextual data 127, user data, and/or support provider data.

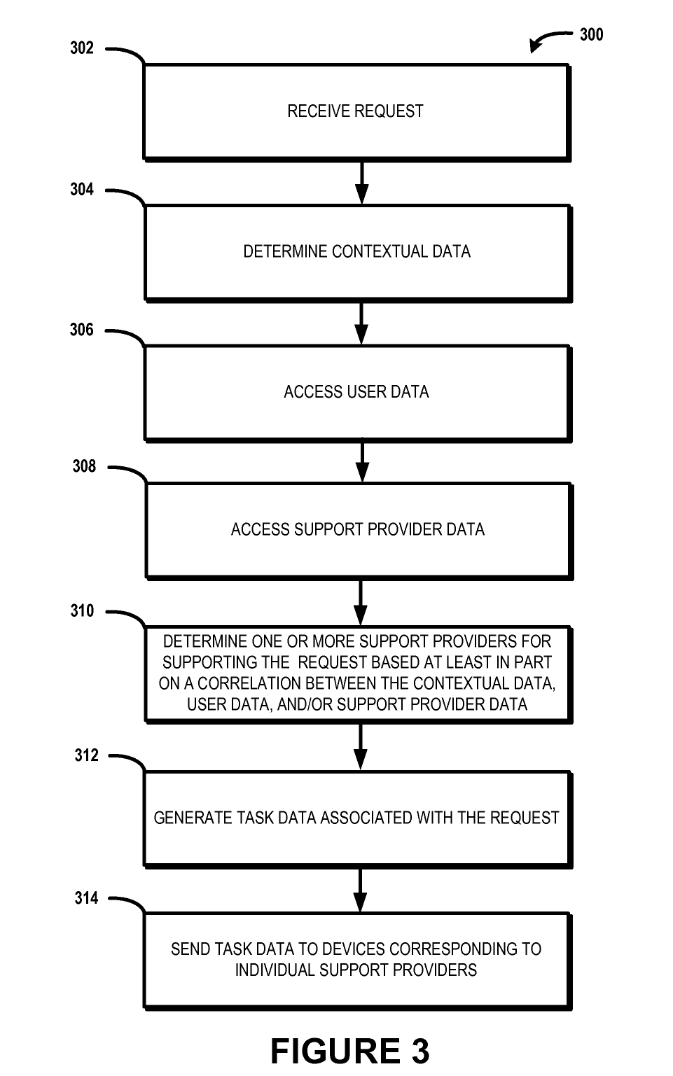

In at least one example, the request routing module 134 can determine the one or more support providers for routing requests 116 to based at least in part on determining whether individual support providers of the one or more support providers are available. In other examples, the request routing module 134 can determine one or more support providers for routing requests 116 to without regard to whether support providers are available. In such examples, based at least in part on determining that some of the one or more support providers are not available, the request routing module 134 can prompt a user to determine whether the user prefers support at the time with the support providers that are available or prefers to wait for one of the unavailable support providers to become available. Additional details associated with determining the one or more support providers for routing requests is described below in FIG. 3.

The task management module 136 can be configured to receive and/or access the requests 116 and generate task data 137 that corresponds to individual requests 116. The task data 137 can include a request 116, contextual data 127, user data corresponding to the user who submitted the request 116 (e.g., name, contact information, etc.), a timestamp corresponding to when the user submitted the request 116, etc. The task management module 136 can arrange the tasks in task lists 122 associated with individual support providers. As described above, a task list 122 can include one or more tasks corresponding to individual requests 116. The task management module 136 can cause a display of a graphical element corresponding to task data 137 to be presented as a task in a graphical representation of the task list 122 presented on devices corresponding to one or more support providers (e.g., support provider device(s) 106).

In at least one example, the task management module 136 can be configured to determine that a support provider corresponding to a support provider device of the support provider device(s) 106 accepts a task on the task list 122 based at least in part on data received from the program module 112B. That is, the task management module 126 can determine that the support provider accepts a particular request 116. Based at least in part on determining that a support provider accepts a request 116, the task management module 136 can remove the task from task lists 122 associated with other support providers. The task management module 136 can remove the task by removing the task data 137 from the task lists 122 and by terminating causing the display of the graphical element corresponding to the task data 137 on the task list 122 presented on the support provider device(s) 106.

The feedback module 138 can be configured to receive feedback data from users. In at least one example, the feedback module 138 can prompt users for feedback based at least in part on a user and/or support provider indicating that the request 116 is resolved (e.g., the user and/or support provider actuate corresponding controls indicating that the request 116 is resolved), observing that the request 116 is resolved (e.g., the domain has been migrated and the user is using the new domain, etc.), etc. In other examples, the feedback module 138 can prompt users for feedback based at least in part on determining that the request 116 timed out (e.g., is not resolved for a predetermined period of time). The feedback data can be associated with individual support providers and/or the overall customer support experience. The feedback data can include positive, negative, or neutral feedback about individual support providers and/or customer support experiences.

In some examples, the feedback module 138 can prompt the user for feedback via various mechanisms. In at least one example, a graphical element corresponding to a feedback survey can be caused to be presented to users of the user device(s) 104. The feedback survey can include one or more questions for collecting feedback data (e.g., multiple choice questions, Likert questions, fill-in-the-blank questions, freeform questions, etc.). The feedback module 138 can process the feedback data (e.g., via a heuristic, etc.) to determine a score or rating associated with individual support providers.

The performance module 140 can determine performance data associated with users, individual support providers, and/or all support providers who have support provider profile(s) 132 with the support application. With respect to users, the performance module 140 can determine a number of requests 116 made by a user, a number of requests 116 made by the user that were accepted, accepted and resolved, declined, timed out (e.g., unresolved after a predetermined period of time), etc., a frequency in which the user makes requests 116, etc.

With respect to individual support providers, the performance module 140 can determine a number of requests 116 accepted and/or serviced by a support provider, a number of requests 116 in which the support provider makes contact with a user associated with a request 116, a number of requests 116 that have been resolved by the support provider (e.g., as determined by the support provider and/or the user), etc. The performance module 140 can also leverage timestamps associated with requests 116 and responses to determine a lapse of time between when a request 116 is sent and a response is sent and/or received (i.e., time lapsed prior to a support provider accepting the request 116), a lapse of time between when a request 116 is sent and when a request 116 is resolved (i.e., time lapsed prior to resolution of the request 116), etc. Additionally, the performance module 140 can determine a number of responses sent to a user, an amount of time a support provider spent waiting on the user, etc. In some examples, the support provider who originally accepted the request 116 may not be able to resolve the request 116. Accordingly, the support provider can communicate with other support providers to resolve the request 116, or the server 108 can send the request 116 to another support provider. In such examples, the performance module 140 can determine a number of support providers that worked on resolving the request 116, etc. The performance module 140 can compute a number of requests 116 a support provider accepts and/or resolves per day. Additionally, the performance module 140 can access the feedback data to determine ratings associated with individual support providers. In at least one example, the performance module 140 can leverage net satisfaction scoring (NSAT) to rate individual support providers.

Additionally and/or alternatively, the performance module 140 can determine aggregated data associated with all of the support providers that have support provider profile(s) 132 associated with the support application. In at least one example, the performance module 140 can receive, access, and/or determine a number of requests 116 accepted and/or serviced by all of the support providers, a number of requests 116 in which the all of the support providers make contact with users associated with requests 116, a number of requests 116 that have been resolved by all of the support providers (e.g., as determined by the support providers and/or the users), etc. The performance module 140 can also receive, access, and/or determine averages of lapses of time between when requests 116 are sent and responses are received, lapses of time between when requests 116 are sent and when requests 116 are resolved, etc. Additionally, the performance module 140 can determine an average number of responses sent to users, an average amount of time a support provider spent waiting on the user, etc. The performance module 140 can determine an average number of support providers that worked on resolving a request 116, etc. Additionally, the performance module 140 can access the feedback data to determine ratings associated with the support application based on the performance of all of the support providers. In at least one example, the performance module 140 can leverage net satisfaction scoring (NSAT) for determining user satisfaction of the support application.

In some examples, the performance module 140 can leverage the feedback data, performance data, and/or aggregated data to evaluate each support provider that has a support provider profile 132. In at least one example, the performance module 140 can rank each of the support providers based on the ratings associated with the individual support providers. For instance, in a non-limiting example, the performance module 140 can perform top-box/bottom-box percentile computations to determine how to rank each support provider. In additional or alternative examples, if a support provider is a support provider with two or more sub-support providers, the performance module 140 can rank each of the sub-support providers associated with the support provider based on the ratings associated with each of the sub-support providers.

In some examples, a predetermined number of top ranking support providers and/or support providers ranked above a predetermined threshold can receive benefits that lower ranking support providers do not receive. For instance, top ranking support providers and/or support providers ranked above a predetermined threshold can receive higher compensation per request 116 accepted than lower ranking support providers. In other examples, top ranking support providers and/or support providers ranked above a predetermined threshold can receive authorizations to access additional and/or alternative requests 116 that lower ranking support providers do not have access to and/or top ranking support providers and/or support providers ranked above a predetermined threshold can receive access to requests 116 before lower ranking support providers.

The performance module 140 can leverage the feedback data, performance data, etc. to reward individual support providers, In some examples, the performance module 140 can credit an account associated with a support provider profile 132 based at least in part on determining that the support provider corresponding to the support provider profile 132 accepts a request 116, accepts a number of requests 116 above a predetermined number, resolves a request 116, resolves a number of requests 116 above a predetermined number, receives a rating above a predetermined threshold, is ranked above a predetermined rank, etc. The amount of the credit can vary based on the expertise of the support provider, the length of time the support provider has had a support provider profile 132 associated with the support application, the rating and/or ranking associated with the support provider, etc. In other examples, the performance module 140 can provide the support provider corresponding to the support provider profile 132 additional and/or alternative rewards. For instance, the performance module 140 can provide the support provider with first rights of refusal for particular requests, access to incoming requests prior to other support providers, additional and/or alternative access rights, etc. As described above, the performance module 140 can provide additional and/or alternative rewards based at least in part on the expertise of the support provider, the length of time the support provider has had a support provider profile 132 associated with the support application, the rating and/or ranking associated with the support provider, etc.

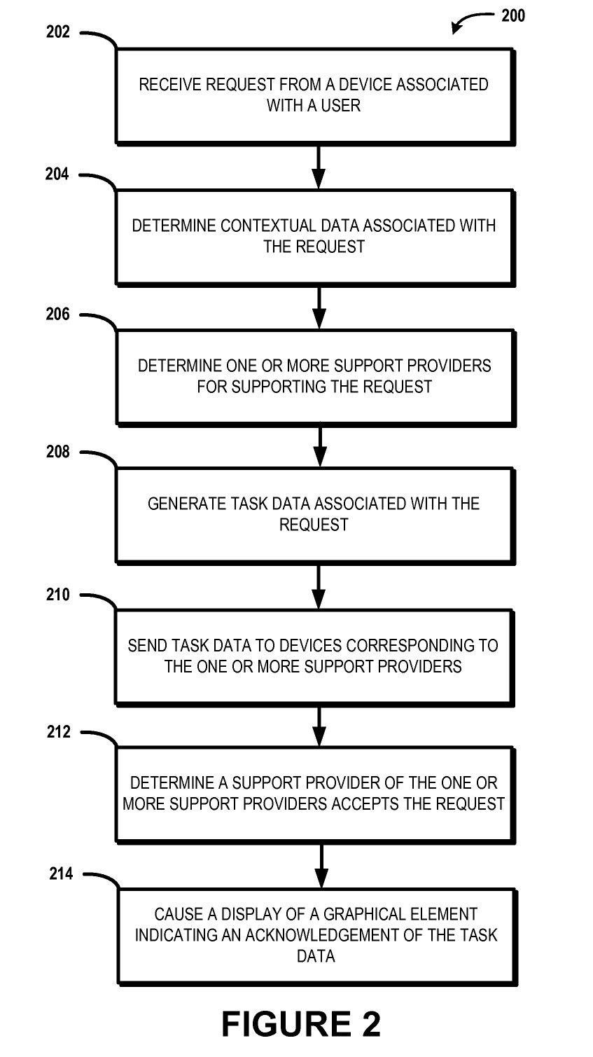

FIG. 2 is a flow diagram illustrating aspects of a method for enabling real-time support of a request 116 based at least in part on contextual data 127. It should be appreciated that the logical operations described herein with respect to FIG. 2, and the other FIGURES, can be implemented (1) as a sequence of computer implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations can be performed than shown in the FIGURES and described herein. These operations can also be performed in parallel, or in a different order than those described herein. Some or all of these operations might also be performed by components other than those specifically identified.

Block 202 illustrates receiving a request from a device associated with a user (e.g., user device 104). In at least one example, the program module 112A can send requests 116 to the program module 112C. As described above, requests 116 can include onboarding requests, support requests, managing requests, troubleshooting requests, requests for directions, etc. In at least one example, the program module 112A can send requests 116 based at least in part on determining that a user actuates a control on a user interface associated with a product, a service, etc. As described below, the control can be caused to be presented based at least in part on a number of support providers that are available. In other examples, the program module 112A can send requests 116 based at least in part on receiving additional and/or alternative inputs including, but not limited to, voice input, gaze input, etc. In additional and/or alternative examples, the program module 112A can send requests 116 based at least in part on determining that a user has not interacted with a corresponding user device 104 for a predetermined amount of time. That is, the program module 112A can send requests 116 based at least in part on determining a user has been idle for a predetermined amount of time. In other examples, the program module 112A can send requests 116 without user input. For instance, the program module 112A can send requests 116 at a predetermined frequency, after a lapse of a predetermined period of time, responsive to and/or in anticipation of triggering events. Triggering events can include subscription expirations, subscription renewals, password expirations, new features, etc.

Block 204 illustrates determining contextual data 127 associated with the request 116. The contextual data determination module 126 can be configured to receive, access, and/or generate contextual data 127. As described above, contextual data 127 can be received and/or accessed from any number of resources and contextual data 127 can be in any format. Contextual data 127 can be data that can define a status of an application associated with a product, service, etc., a status of an interface associated with a product, service, etc., etc. In at least one example, contextual data 127 can be obtained by an analysis of an application, an interface associated with a product, service, etc., as described above.

Block 206 illustrates determining one or more support providers for supporting the request 116. As described above, the request routing module 134 can be configured to determine one or more support providers for routing requests 116. The request routing module 134 can access user data associated with the user profile(s) 130 and/or support provider data associated with the support provider profile(s) 132. Additionally, the request routing module 134 can access the request 116 and/or the contextual data 127, as described above. The request routing module 134 can compare the request 116, the contextual data 127, and/or the user data with the support provider data and, based at least in part on comparing the request 116, the contextual data 127, and/or the user data with the support provider data, can determine one or more support providers for supporting the request 116. Additional details associated with determining the one or more support providers for routing requests 116 is described above and also below in FIG. 3.

Block 208 illustrates generating task data 137 associated with the request 116. The task management module 136 can be configured to receive and/or access the request 116 and generate task data 137 that corresponds to the request 116. The task data 137 can include the request 116, contextual data 127, user data corresponding to the user who submitted the request 116 (e.g., name, contact information, etc.), a timestamp corresponding to when the user submitted the request 116, etc. The task management module 136 can arrange the task data 137 in task lists 122 associated with individual support providers of the one or more support providers selected by the request routing module 134 as described above. As described above, a task list 122 can include one or more tasks corresponding to individual requests 116.

Block 210 illustrates sending the task data 137 to devices corresponding to individual support providers (e.g., support provider device(s) 106). In at least one example, the task management module 136 can send a communication associated with the task data 137 to the support provider device(s) 106. In additional and/or alternative examples, the task management module 136 can cause a display of a graphical element corresponding to task data 137 to be presented as a task in a graphical representation of a task list 122 presented on devices corresponding to the one or more support providers (e.g., support provider device(s) 106) selected by the request routing module 134 as described above.

Block 212 illustrates determining a support provider of the one or more support providers accepts the request 116. The user interfaces associated with the task list(s) 122 can be configured to provide functionality for support providers to accept individual tasks on the task list(s) 122. As non-limiting examples, a support provider can actuate a control associated with a graphical representation of task data to indicate that the support provider acknowledges the task, or a support provider can interact with the graphical representation of task data to acknowledge the task. In at least one example, the task management module 136 can receive a response indicating that a support provider acknowledges a task and the task management module 136 can be configured to determine that a support provider accepts the task. The response can be associated with acknowledgment data indicating an acknowledgement of the task data. The task management module 136 can determine that the support provider accepts the task based at least in part on the acknowledgement data.

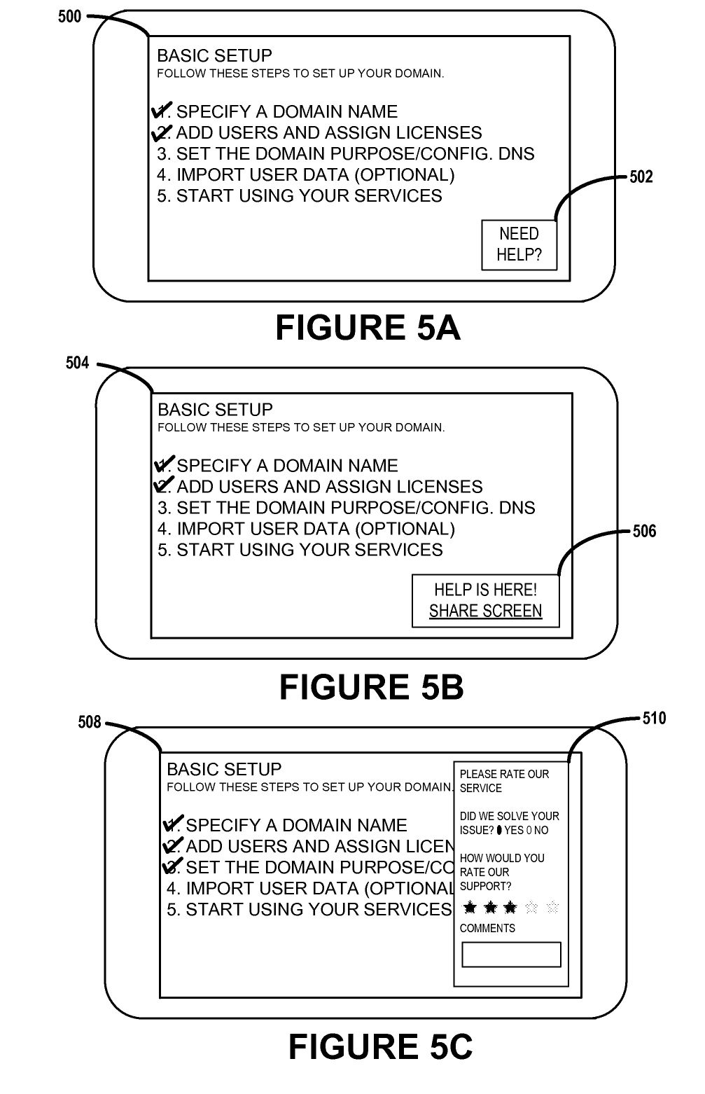

Block 214 illustrates causing a display of a graphical element indicating an acknowledgement of the task data. In at least one example, the program module 112C can generate a notification indicating the acknowledgement of the task data. The notification can include a display of a graphical element, an audio signal, a message, a status change of at least one component of a computing device, etc. In some examples, program module 112C can be configured to send a response to the user device 104. The response can include the notification that the request 116 has been accepted. In at least one example, the response can be associated with a push notification, a text message, an email, etc. In other examples, the response can be associated with a control and/or graphical element corresponding to the control that the program module 112A can cause to be presented on a user interface associated with a display of the user device 104. An example of the graphical element indicating the acknowledgement that can be caused to be displayed can be a control 506 as illustrated in FIG. 5B. In some examples, the response can include information about when the user associated with the request 116 can expect to receive contact (e.g., a call, email, message, etc.) from the support provider, directions for performing an action, a mechanism for creating the shared meeting space, etc.

FIG. 3 is a flow diagram illustrating aspects of a method 300 for determining one or more support providers for supporting the request 116 and causing a graphical element corresponding to the request 116 to be presented on devices corresponding to the one or more support providers (e.g., support provider device(s) 106).

Block 302 illustrates receiving a request 116, as described above.

Block 304 illustrates determining contextual data 127, as described above.

Block 306 illustrates accessing user data. As described above, the data manager 128 can receive and/or access data associated with the individual users (e.g., user data). The user data can be stored in user profile(s) 130 corresponding to user identifier(s) 114. Non-limiting examples of data associated with the individual users can include an identity of the user, a number of employees employed by the user, a type of a subscription associated with the user (e.g., the level of support services the user subscribes), a length of the subscription associated with the user (e.g., how long the user has subscribed to the support services), a location of the user, a language of the user, a history of requests associated with the user, feedback provided by the user, etc. Additional and/or alternative types of data associated with the individual users are described above.

Block 308 illustrates accessing support provider data. As described above, the data manager 128 can receive and/or access data associated with the individual support providers (e.g., support provider data). The support provider data can be stored in support provider profile(s) 132 corresponding to support provider identifier(s) 120. In at least one example, data associated with individual support providers can include an availability of a support provider, an expertise associated with the support provider, an authorization associated with the support provider, a language of the support provider, a geographic location of the support provider, feedback associated with the support provider, a rating associated with the support provider, a quota of requests 116 associated with the support provider, a compensation structure associated with the support provider, etc. Additional and/or alternative types of data associated with the support providers are described above.

Block 310 illustrates determining one or more support providers for supporting the request 116 based at least in part on a correlation between the contextual data, user data, and/or support provider data. The request routing module 134 can access the user data and/or the support provider data. Additionally, the request routing module 134 can access the request 116 and/or the contextual data 127, as described above. The request routing module 134 can determine individual support providers to send the request 116 to based at least in part on comparing the request 116, contextual data 127, and/or user data with the support provider data. In at least one example, the request routing module 134 can determine the individual support providers to route the request 116 to based on determining a correlation between the contextual data 127 and/or support provider data. In some examples, the request routing module 134 can determine the individual support providers to route the request 116 to based on rules determined by the support application. In such examples, the request routing module 134 can leverage machine learning algorithms (e.g., supervised, unsupervised, deep learning, etc.) to determine rules for routing requests 116.

As a non-limiting example, the request routing module 134 can access user data and determine, from the user data, that a user is a valuable customer that has been a subscriber to a product for a period of time greater than a threshold amount of time. Additionally, the request routing module 134 can access the request 116 and/or contextual data 127. Based at least in part on analyzing the contextual data 127, the request routing module 116 can determine that the user is trying to migrate a domain and is stuck on the third step of a domain migration wizard application. Moreover, the request routing module 134 can access support provider data, and determine, from the support provider data, a plurality of individual support providers who have the expertise to resolve the request 116 (e.g., migrating the domain) and have a rating above a predetermined threshold. Accordingly, the request routing module 134 can determine to route the request to the plurality of individual support providers. That is, the request routing module 134 can route requests 116 from valuable customers to high rating support providers to maximize the satisfaction of the valuable customers.

In an additional and/or alternative non-limiting example, the request routing module 134 can access user data and determine, from the user data, that a user is an English speaking user who lives in Seattle, Wash. (e.g., Pacific Standard Time). Additionally, the request routing module 134 can access the request 116 and/or contextual data 127. Based at least in part on analyzing the contextual data 127, the request routing module 116 can determine that the user is trying to upload a photo via a social networking services application. Moreover, the request routing module 134 can access support provider data, and determine, from the support provider data, that a plurality of individual support providers who have the expertise to resolve the request 116 (e.g., upload a photo via the social networking services application), who are also English speaking and are located in a geographic location in a same time zone as the user or a time zone a predetermined number of time zones away from the same time zone as the user. Accordingly, the request routing module 134 can determine to route the request 116 to the plurality of individual support providers. That is, the request routing module 134 can route requests 116 associated with users who speak a certain language and live in a certain area with support providers who speak the same language and are in a similar time zone to maximize the satisfaction of the users.

In an additional and/or alternative non-limiting example, the request routing module 134 can access user data and determine, from the user data, that a user is a new user (e.g., a subscriber for a period of time below a threshold) and that the user has initiated a number of requests 116 above a predetermined frequency.

Additionally, the request routing module 134 can access the request 116 and/or contextual data 127. Based at least in part on analyzing the contextual data 127, the request routing module 116 can determine that the user received a reminder about downloading security software in an electronic communication associated with a mail services application. Moreover, the request routing module 134 can access support provider data, and determine, from the support provider data, that a plurality of individual support providers who have the expertise to resolve the request 116 (e.g., recommend and help procure security software) and are associated with a compensation structure that pays the individual support providers at a rate below a threshold value (e.g., support providers who are compensated $1.00/request vs. support providers who are compensated $1000.00/request). Accordingly, the request routing module 134 can determine to route the request 116 to the plurality of individual support providers. That is, the request routing module 134 can route requests 116 associated with new users who frequently ask questions to support providers who are relatively inexpensive to maximize the satisfaction of the new users without causing excessive costs to a service provider (e.g., an entity ultimately paying the support providers for their support services).

Block 312 describes generating task data 137 associated with the request 116, as described above.

Block 314 illustrates sending the task data 137 to devices corresponding to individual support providers (e.g., support provider device(s) 106), as described above.

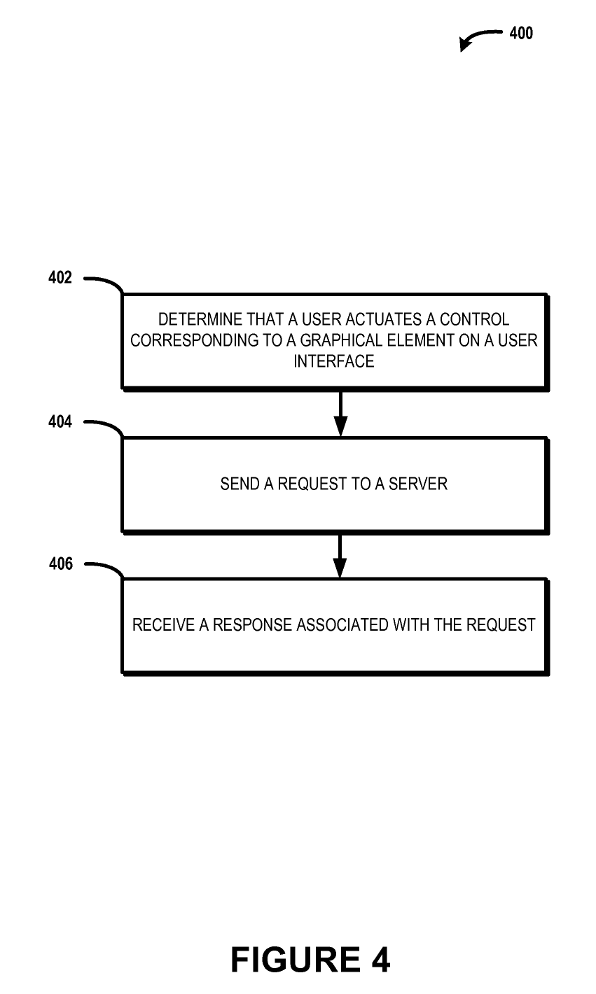

FIG. 4 is a flow diagram illustrating aspects of a method 400 for enabling real-time support for requests 116 based at least in part on contextual data 127. FIG. 4 can represent a method from the perspective of the user device(s) 104.

Block 402 illustrates determining that a user actuates a control corresponding to a graphical element on a user interface of a user device 104. The program module 112A can determine that a user actuates a control configured to provide the user with functionality to submit a request 116 associated with at least one of a product, a service, etc. To prevent a situation where a user actuates the control and does not receive a response because the number of requests 116 substantially outweighs the number of available support providers, in some examples, the program module 112A may not cause the control to be presented until the program module 112C has determined that the number of support providers that are available exceeds a threshold number. In such an example, the program module 112C can access support provider data to determine a number of support providers that are available at a particular time. Based at least in part on determining that the number of support providers that are available at the particular time equals or exceeds a threshold value, the program module 112C can send data to the program module 112A and the program module 112A cause the control to be presented on the user interface.

In some examples, data inputs can be associated with the control. In at least one example, a data input associated with a control can include a freeform text box for a user to input his or her contact information (e.g., phone number, email address, etc.). In some examples, the information requested via a data input can depend on the number of available support providers at a time a request 116 is submitted. In at least one example, based at least in part on determining that the number of available support providers meets or exceeds a threshold value, the program module 112A can cause a data input requesting a first type of information to be presented with the control. In an example, the first type of information can be a phone number. Additionally and/or alternatively, based at least in part on determining that the number of available support providers is below a threshold value, the program module 112A can cause a data input requesting a second type of information to be presented with the control. The second type of information can be different from the first type of information. For instance, the second type of information can be an email address. In additional and/or alternative examples, the data inputs can request contextual data 127, as described below.

FIG. 5A is a block diagram showing an example user interface 500 presenting a graphical element corresponding to a control 502 for providing users with functionality to submit a request 116. As a non-limiting example, in FIG. 5A, a user can be interacting with a wizard application providing the user with instructions on how to set up his or her domain. When the user needs support, the user can actuate the control 502 to submit a request 116. Based at least in part on determining that the user actuates the control 502, the program module 112A can determine a request 116. In FIG. 5A, the user can have completed step one and step two (as indicated by the checkmarks) but can be stuck on step three. Accordingly, the user can actuate the control 502 to submit a request 116.

Returning to FIG. 4, block 404 illustrates sending a request 116 to the server 108. As described above, the program module 112A can determine a request 116 based at least in part on determining that the user actuates the control 502 and can send the request 116 to the program module 112C on the server 108.

Block 406 illustrates receiving a response associated with the request 116. As described above, the program module 112A can be configured receive responses from the support provider device(s) 106 and/or the server 108. In some examples, the responses can include notifications indicating the acknowledgement of the task data 137.

FIG. 5B is a block diagram showing an example user interface 504 presenting a graphical element corresponding to a control 506 for notifying users that a request 116 was received (e.g., acknowledged) and providing users with functionality to join a shared meeting. Based at least in part on the program module 112A sending a request 116 to the support provider device(s) 106 and/or the server 108, the program module 112B can create a mechanism for creating a shared meeting space between the user and the support provider. The program module 112B can send the mechanism to the program module 112A (in some examples via program module 112C) and the program module 112A can cause the mechanism to be presented in association with the control 504. Accordingly, the user can actuate the mechanism (e.g., select the link corresponding to the shared meeting space) and the support provider and user can connect via the shared meeting space (e.g., WEBEX®, SKYPE®, GOOGLE+ HANGOUTS®, Screenleap, UberConference™, LYNC®, LOGMEIN®, etc.). In some examples, the user can share his or her screen with the support provider via the shared meeting space using some of the technologies above.

In some examples, based at least in part on the support provider accepting and/or resolving the request 112, the feedback module 138 can send a mechanism for receiving feedback from the user about at least one of the support provider or resolution of the request 116. The feedback module 138 can cause a graphical element corresponding to the mechanism for receiving feedback to be presented to the user via a user interface on a display of the user device(s) 104. FIG. 5C is a block diagram showing an example user interface 508 presenting a graphical element corresponding to a mechanism 510 for providing users with functionality to provide feedback associated with the support experience. In some examples, the mechanism can comprise a feedback survey. As described above, the feedback survey can include one or more questions for collecting feedback data (e.g., multiple choice questions, Likert questions, fill-in-the-blank questions, freeform questions, etc.). Additional and/or alternative layouts can be associated with the feedback survey than what is shown in FIG. 5C.

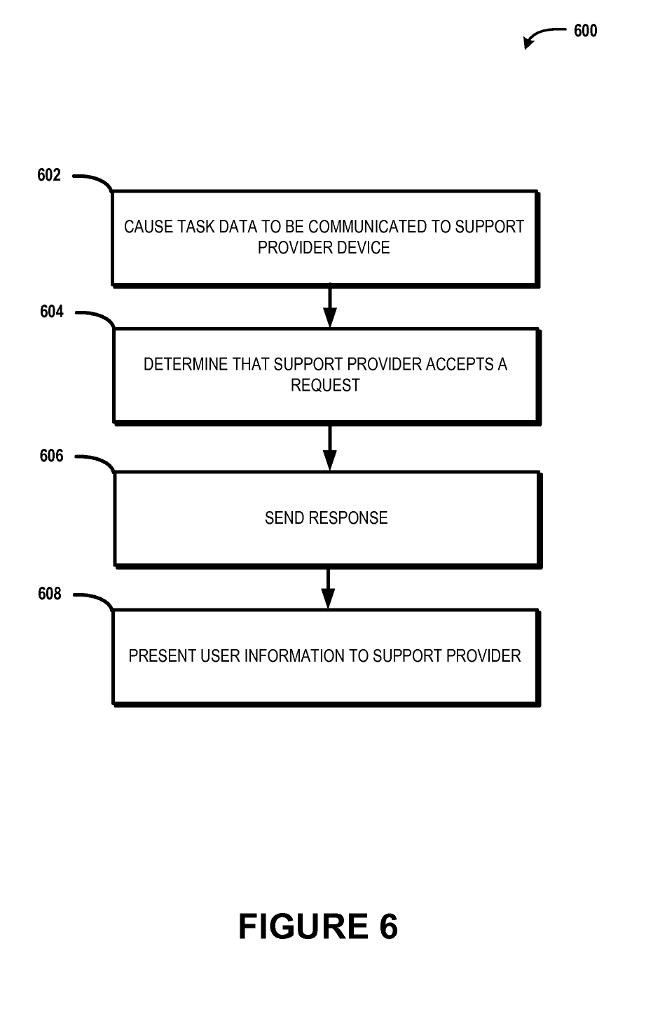

FIG. 6 is a flow diagram illustrating aspects of a method 600 for presenting user information corresponding to a request 116 to a support provider based at least in part on the support provider accepting the request 116.

Block 602 illustrates causing task data 137 to be communicated to a support provider device. As described above, the task management module 136 can be configured to receive and/or access the requests 116 and generate task data 137 that corresponds to the requests 116. The task management module 136 can arrange the tasks in task lists 122 corresponding to individual support providers, based at least in part on the task data 137. The task management module 136 can send task data 137 and can cause graphical elements corresponding to the task data 137 to be presented in a graphical representation of a task list 122 on a user interface via a display of a corresponding support provider device(s) 106. As described above, in some examples, based at least in part on adding a new task to the task list 136, the task management module 136 can cause a notification to be presented to the support provider. The notification can include a push notification, text message, email, etc., that notifies the support provider that a new task has been added to the task list 122 corresponding to the support provider. In other examples, the support provider can simply view its task list 122 and observe that a new task has been added based at least in part on observing a new graphical element corresponding to the new task data 137.

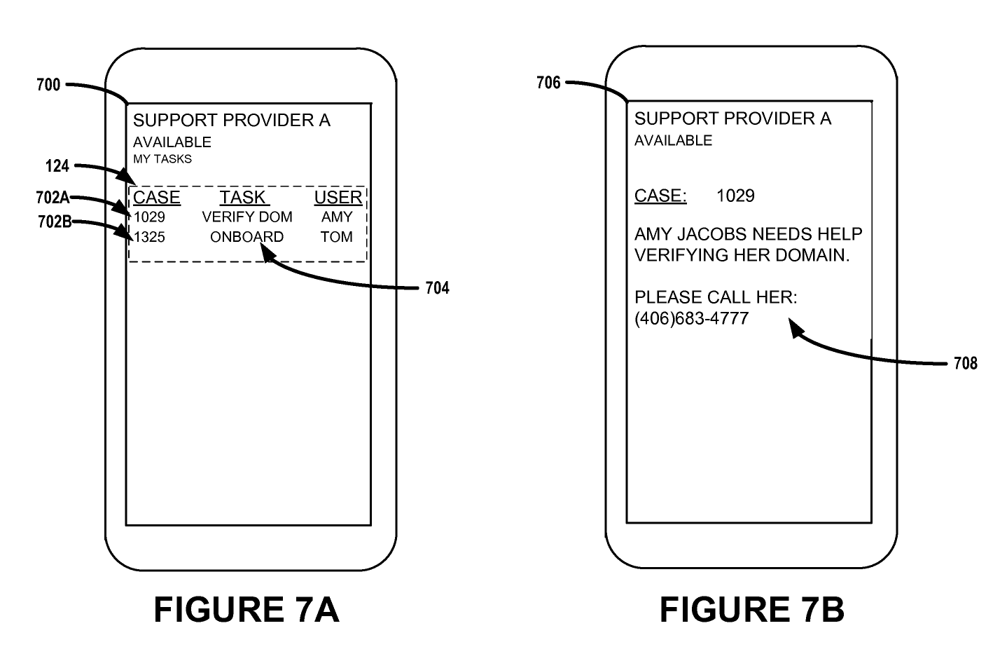

FIG. 7A is a block diagram showing an example user interface 700 presenting a graphical representation of a task list 122 including one or more tasks (e.g., 702A, 702B). Each task (e.g., 702A, 702B) is represented by a graphical element corresponding to task data 137 associated with each task (e.g., 702A, 702B). As illustrated in FIG. 7A, the task list 122 includes contextual data 704 associated with each task (e.g., 702A, 702B) (e.g., verify domain, onboard). The task list 122 illustrated in FIG. 7A can be associated with a particular support provider and other support providers can have same or different task lists 122 depending on how the request routing module 134 determines to route the requests 116. Additional or alternative layouts or presentations are available.

Returning to FIG. 6, block 604 illustrates determining that the support provider accepts the request 106. The user interface presenting the task list 122 can be configured to provide functionality for the support provider to accept individual tasks (e.g., 702A, 702B) on the task list 122 (e.g., via touch input, voice input, etc.). In at least one example, the task management module 136 can be configured to determine that a support provider corresponding to the support provider device(s) 106 accepts a task (e.g., 702A, 702B) on the task list 122 based at least in part on detecting input from the support provider via a corresponding support provider device 106. In at least one example, the input can generate acknowledgement data indicating an acknowledgement of the task (e.g., 702A, 702B).

Block 606 illustrates sending a response. The program module 112B can be configured to send responses to the user device(s) 104 and/or the server 108. The responses can include notifications that a request 116 has been acknowledged and/or accepted, mechanisms for creating shared meeting spaces for users associated with user devices (e.g., user device(s) 104) and support providers associated with support provider devices (e.g., support provider device(s) 106), requests for additional information, etc.

Block 608 illustrates presenting user information to the support provider. Based at least in part on determining that the support provider accepted the request 116, the task management module 126 can cause information associated with the user (e.g., phone number, email address, etc.) to be presented to the support provider via the support provider device(s) 106. FIG. 7B is a block diagram showing an example user interface 706 presenting user information 708 corresponding to a request 116. As shown in FIG. 7B, the user information 708 includes the name of the user (e.g., Amy Jacobs), contextual data 127 (e.g., needs help verifying her domain), and contact information (e.g., phone number). Additional and/or alternative data can be presented to the support provider.

FIG. 8 shows additional details of an example computer architecture 800 for a computer, such as first computing entity 104, a support provider device 106, and/or a server 108 (FIG. 1), capable of executing the program components described above for enabling real-time support based at least in part on contextual data 127. Thus, the computer architecture 800 illustrated in FIG. 8 illustrates an architecture for a server computer, mobile phone, a PDA, a smart phone, a desktop computer, a netbook computer, a tablet computer, and/or a laptop computer. The computer architecture 800 can be utilized to execute any aspects of the software components presented herein.

The computer architecture 800 illustrated in FIG. 8 includes a central processing unit 802 (“CPU”), a system memory 804, including a random access memory 806 (“RAM”) and a read-only memory (“ROM”) 806, and a system bus 810 that couples the memory 804 to the CPU 802. A basic input/output system containing the basic routines that help to transfer information between elements within the computer architecture 800, such as during startup, is stored in the ROM 806. The computer architecture 800 further includes a mass storage device 812 for storing an operating system 807, and one or more application programs including but not limited to the program module 112A, etc.

The mass storage device 812 is connected to the CPU 802 through a mass storage controller (not shown) connected to the bus 810. The mass storage device 812 and its associated computer-readable media provide non-volatile storage for the computer architecture 800. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media can include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 800. For purposes the claims, the phrase “computer storage medium,” “computer-readable storage medium” and variations thereof, does not include waves, signals, and/or other transitory and/or intangible communication media, per se.

According to various configurations, the computer architecture 800 can operate in a networked environment using logical connections to remote computers through the network 102 and/or another network (not shown). The computer architecture 800 can connect to the network 102 through a network interface unit 814 connected to the bus 810. It should be appreciated that the network interface unit 814 also can be utilized to connect to other types of networks and remote computer systems. The computer architecture 800 also can include an input/output controller 816 for receiving and processing input from a number of other devices, including a keyboard, mouse, or electronic stylus (not shown in FIG. 8). Similarly, the input/output controller 816 can provide output to a display screen, a printer, or other type of output device (also not shown in FIG. 8).

It should be appreciated that the software components described herein can, when loaded into the CPU 802 and executed, transform the CPU 802 and the overall computer architecture 800 from a general-purpose computing system into a special-purpose computing system customized to facilitate the functionality presented herein. The CPU 802 can be constructed from any number of transistors or other discrete circuit elements, which can individually or collectively assume any number of states. More specifically, the CPU 802 can operate as a finite-state machine, in response to executable instructions contained within the software modules disclosed herein. These computer-executable instructions can transform the CPU 802 by specifying how the CPU 802 transitions between states, thereby transforming the transistors or other discrete hardware elements constituting the CPU 802.

Encoding the software modules presented herein also can transform the physical structure of the computer-readable media presented herein. The specific transformation of physical structure can depend on various factors, in different implementations of this description. Examples of such factors can include, but are not limited to, the technology used to implement the computer-readable media, whether the computer-readable media is characterized as primary or secondary storage, and the like. For example, if the computer-readable media is implemented as semiconductor-based memory, the software disclosed herein can be encoded on the computer-readable media by transforming the physical state of the semiconductor memory. For example, the software can transform the state of transistors, capacitors, or other discrete circuit elements constituting the semiconductor memory. The software also can transform the physical state of such components in order to store data thereupon.

As another example, the computer-readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations also can include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 800 in order to store and execute the software components presented herein. It also should be appreciated that the computer architecture 800 can include other types of computing entities, including hand-held computers, embedded computer systems, personal digital assistants, and other types of computing entities known to those skilled in the art. It is also contemplated that the computer architecture 800 may not include all of the components shown in FIG. 8, can include other components that are not explicitly shown in FIG. 8, or can utilize an architecture completely different than that shown in FIG. 8.

FIG. 9 depicts an illustrative distributed computing environment 900 capable of executing the software components described herein for providing real-time support based at least in part on contextual data. Thus, the distributed computing environment 900 illustrated in FIG. 9 can be utilized to execute any aspects of the software components presented herein. For example, the distributed computing environment 900 can be utilized to execute aspects of the modules and/or other software components described herein.

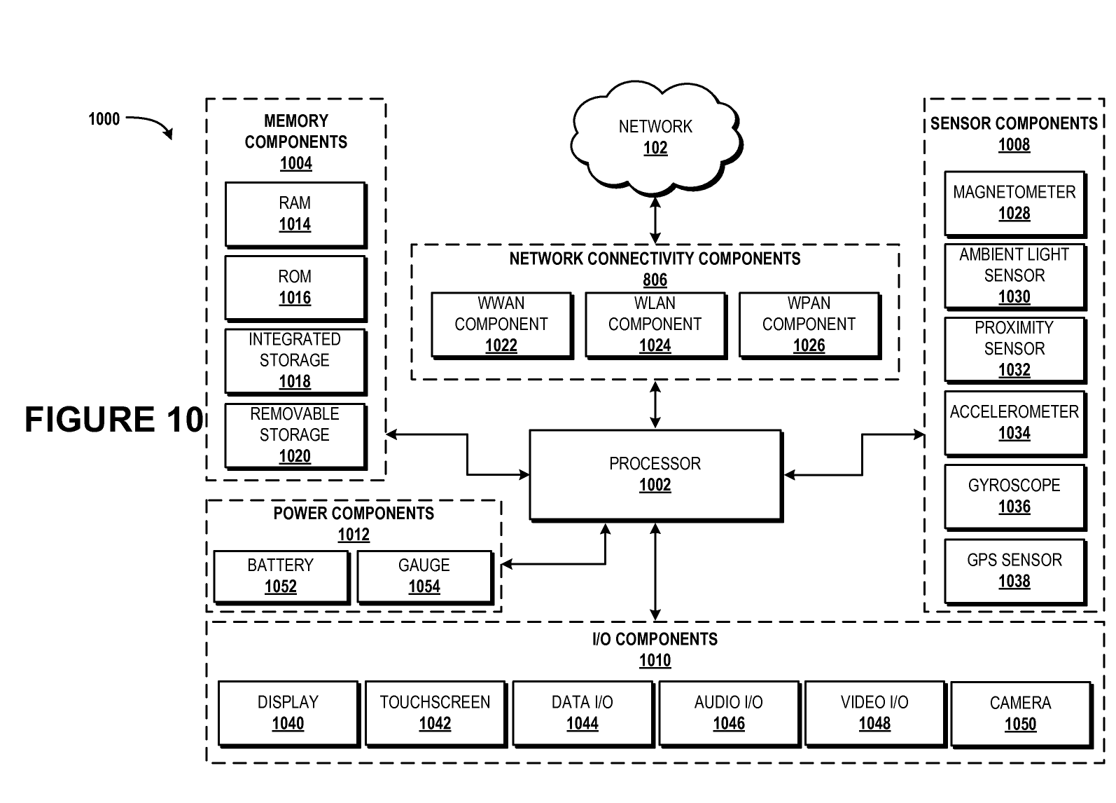

According to various implementations, the distributed computing environment 900 includes a computing environment 902 operating on, in communication with, or as part of the network 102. The network 102 can be or can include the network 102, described above with reference to FIG. 8. The network 102 also can include various access networks. One or more client devices 906A-906N (hereinafter referred to collectively and/or generically as “clients 906”) can communicate with the computing environment 902 via the network 102 and/or other connections (not illustrated in FIG. 9). Individual of the one or more client devices 906A-906N can correspond to the user device(s) 104 and/or support provider device(s) 106. In one illustrated configuration, the clients 906 include a computing device 906A such as a laptop computer, a desktop computer, or other computing device; a slate or tablet computing device (“tablet computing device”) 906B; a mobile computing device 906C such as a mobile telephone, a smart phone, or other mobile computing device; a server computer 906D; and/or other devices 906N. It should be understood that any number of clients 906 can communicate with the computing environment 902. Two example computing architectures for the clients 906 are illustrated and described herein with reference to FIGS. 8 and 10. It should be understood that the illustrated clients 906 and computing architectures illustrated and described herein are illustrative, and should not be construed as being limited in any way.

In the illustrated configuration, the computing environment 902 includes application servers 908, data storage 910, and one or more network interfaces 912. According to various implementations, the functionality of the application servers 908 can be provided by one or more server computers that are executing as part of, or in communication with, the network 102. Server 108 can correspond to the computing environment 902. The application servers 908 can host various services, virtual machines, portals, and/or other resources. In the illustrated configuration, the application servers 908 can host one or more virtual machines 914 for executing applications or other functionality. According to various implementations, the virtual machines 914 can execute one or more applications and/or software modules for providing real-time support for requests 116 based at least in part on contextual data 127. It should be understood that this configuration is illustrative, and should not be construed as being limiting in any way. The application servers 908 also host or provide access to one or more portals, link pages, Web sites, and/or other information (“Web portals”) 916. The Web portals 916 can be used to communicate with one or more client computer.

According to various implementations, the application servers 908 also include one or more mailbox services 918 and one or more messaging services 920. The mailbox services 918 can include electronic mail (“email”) services. The mailbox services 918 also can include various personal information management (“PIM”) services including, but not limited to, calendar services, contact management services, collaboration services, and/or other services. The messaging services 920 can include, but are not limited to, instant messaging services, chat services, forum services, and/or other communication services.

The application servers 908 also may include one or more social networking services 922. The social networking services 922 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 922 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 922 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 922 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 922 are not mentioned herein for the sake of brevity. As such, the above configurations are illustrative, and should not be construed as being limited in any way. According to various implementations, the social networking services 922 may host one or more applications and/or software modules for providing the functionality described herein for providing contextually-aware location sharing services for computing devices. For instance, any one of the application servers 908 may communicate or facilitate the functionality and features described herein. For instance, a social networking services application, mail client, messaging client, a browser running on a phone or any other client 906 may communicate with a networking service 922 and facilitate the functionality, even in part, described above with respect to FIG. 5.

As shown in FIG. 9, the application servers 908 also can host other services, applications, portals, and/or other resources (“other resources”) 924. The other resources 924 can deploy a service-oriented architecture or any other client-server management software. It thus can be appreciated that the computing environment 902 can provide integration of the technologies disclosed herein provided herein with various mailbox, messaging, social networking, and/or other services or resources.

As mentioned above, the computing environment 902 can include the data storage 910. According to various implementations, the functionality of the data storage 910 is provided by one or more databases operating on, or in communication with, the network 102. The functionality of the data storage 910 also can be provided by one or more server computers configured to host data for the computing environment 902. The data storage 910 can include, host, or provide one or more real or virtual containers 926A-926N (hereinafter referred to collectively and/or generically as “containers 926”). The containers 926, which can be used to form a key container 131 or a secret container 115, are configured to host data used or created by the application servers 908 and/or other data. Although not illustrated in FIG. 9, the containers 926 also can host or store data structures and/or algorithms for execution by a module, such as the program module 112A, etc. Aspects of the containers 926 can be associated with a database program, file system and/or any program that stores data with secure access features. Aspects of the containers 926 can also be implemented using products or services, such as ACTIVE DIRECTORY, DKM, ONEDRIVE, DROPBOX or GOOGLEDRIVE.

The computing environment 902 can communicate with, or be accessed by, the network interfaces 912. The network interfaces 912 can include various types of network hardware and software for supporting communications between two or more computing entities including, but not limited to, the clients 906 and the application servers 908. It should be appreciated that the network interfaces 912 also can be utilized to connect to other types of networks and/or computer systems.

It should be understood that the distributed computing environment 900 described herein can provide any aspects of the software elements described herein with any number of virtual computing resources and/or other distributed computing functionality that can be configured to execute any aspects of the software components disclosed herein. According to various implementations of the technologies disclosed herein, the distributed computing environment 900 provides the software functionality described herein as a service to the clients 906. It should be understood that the clients 906 can include real or virtual machines including, but not limited to, server computers, web servers, personal computers, mobile computing entities, smart phones, and/or other devices. As such, various configurations of the technologies disclosed herein enable any device configured to access the distributed computing environment 900 to utilize the functionality described herein for enabling real-time support for requests 116 based at least in part on contextual data 127, among other aspects. In one specific example, as summarized above, techniques described herein can be implemented, at least in part, by a web browser application that can work in conjunction with the application servers 908 of FIG. 9.

Turning now to FIG. 10, an illustrative computing device architecture 1000 for a computing device that is capable of executing various software components described herein for providing real-time support for requests 116 based at least in part on contextual data 127. The computing device architecture 1000 is applicable to computing entities that facilitate mobile computing due, in part, to form factor, wireless connectivity, and/or battery-powered operation. In some configurations, the computing entities include, but are not limited to, mobile telephones, tablet devices, slate devices, portable video game devices, and the like. The computing device architecture 1000 is applicable to any of the clients 906 shown in FIG. 9. Moreover, aspects of the computing device architecture 1000 can be applicable to traditional desktop computers, portable computers (e.g., laptops, notebooks, ultra-portables, and netbooks), server computers, and other computer systems, such as described herein with reference to FIG. 8. For example, the single touch and multi-touch aspects disclosed herein below can be applied to desktop computers that utilize a touchscreen or some other touch-enabled device, such as a touch-enabled track pad or touch-enabled mouse.

The computing device architecture 1000 illustrated in FIG. 10 includes a processor 1002, memory components 1004, network connectivity components 1006, sensor components 1008, input/output components 1010, and power components 1012. In the illustrated configuration, the processor 1002 is in communication with the memory components 1004, the network connectivity components 1006, the sensor components 1008, the input/output (“I/O”) components 1010, and the power components 1012. Although no connections are shown between the individuals components illustrated in FIG. 10, the components can interact to carry out device functions. In some configurations, the components are arranged so as to communicate via one or more busses (not shown).

The processor 1002 includes a central processing unit (“CPU”) configured to process data, execute computer-executable instructions of one or more application programs, and communicate with other components of the computing device architecture 1000 in order to perform various functionality described herein. The processor 1002 can be utilized to execute aspects of the software components presented herein and, particularly, those that utilize, at least in part, a touch-enabled input.

In some configurations, the processor 1002 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 920P, 1080P, and higher resolution), video games, three-dimensional (“3D”) modeling applications, and the like. In some configurations, the processor 1002 is configured to communicate with a discrete GPU (not shown). In any case, the CPU and GPU can be configured in accordance with a co-processing CPU/GPU computing model, wherein the sequential part of an application executes on the CPU and the computationally-intensive part is accelerated by the GPU.

In some configurations, the processor 1002 is, or is included in, a system-on-chip (“SoC”) along with one or more of the other components described herein below. For example, the SoC can include the processor 1002, a GPU, one or more of the network connectivity components 1006, and one or more of the sensor components 1008. In some configurations, the processor 1002 is fabricated, in part, utilizing a package-on-package (“PoP”) integrated circuit packaging technique. The processor 1002 can be a single core or multi-core processor.

The processor 1002 can be created in accordance with an ARM architecture, available for license from ARM HOLDINGS of Cambridge, United Kingdom. Alternatively, the processor 1002 can be created in accordance with an x86 architecture, such as is available from INTEL CORPORATION of Mountain View, Calif. and others. In some configurations, the processor 1002 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 1004 include a random access memory (“RAM”) 1014, a read-only memory (“ROM”) 1016, an integrated storage memory (“integrated storage”) 1018, and a removable storage memory (“removable storage”) 1020. In some configurations, the RAM 1014 or a portion thereof, the ROM 1016 or a portion thereof, and/or some combination the RAM 1014 and the ROM 1016 is integrated in the processor 1002. In some configurations, the ROM 1016 is configured to store a firmware, an operating system or a portion thereof (e.g., operating system kernel), and/or a bootloader to load an operating system kernel from the integrated storage 1018 and/or the removable storage 1020.

The integrated storage 1018 can include a solid-state memory, a hard disk, or a combination of solid-state memory and a hard disk. The integrated storage 1018 can be soldered or otherwise connected to a logic board upon which the processor 1002 and other components described herein also can be connected. As such, the integrated storage 1018 is integrated in the computing device. The integrated storage 1018 is configured to store an operating system or portions thereof, application programs, data, and other software components described herein.

The removable storage 1020 can include a solid-state memory, a hard disk, or a combination of solid-state memory and a hard disk. In some configurations, the removable storage 1020 is provided in lieu of the integrated storage 1018. In other configurations, the removable storage 1020 is provided as additional optional storage. In some configurations, the removable storage 1020 is logically combined with the integrated storage 1018 such that the total available storage is made available as a total combined storage capacity. In some configurations, the total combined capacity of the integrated storage 1018 and the removable storage 1020 is shown to a user instead of separate storage capacities for the integrated storage 1018 and the removable storage 1020.

The removable storage 1020 is configured to be inserted into a removable storage memory slot (not shown) or other mechanism by which the removable storage 1020 is inserted and secured to facilitate a connection over which the removable storage 1020 can communicate with other components of the computing device, such as the processor 1002. The removable storage 1020 can be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 1004 can store an operating system. According to various configurations, the operating system includes, but is not limited to, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 1006 include a wireless wide area network component (“WWAN component”) 1022, a wireless local area network component (“WLAN component”) 1024, and a wireless personal area network component (“WPAN component”) 1026. The network connectivity components 1006 facilitate communications to and from the network 102 or another network, which can be a WWAN, a WLAN, or a WPAN. Although only the network 102 is illustrated, the network connectivity components 1006 can facilitate simultaneous communication with multiple networks, including the network 102 of FIG. 9. For example, the network connectivity components 1006 can facilitate simultaneous communications with multiple networks via one or more of a WWAN, a WLAN, or a WPAN.

The network 102 can be or can include a WWAN, such as a mobile telecommunications network utilizing one or more mobile telecommunications technologies to provide voice and/or data services to a computing device utilizing the computing device architecture 1000 via the WWAN component 1022. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 102 can utilize various channel access methods (which can or cannot be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications can be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 102 can be configured to provide voice and/or data communications with any combination of the above technologies. The network 102 can be configured to or adapted to provide voice and/or data communications in accordance with future generation technologies.

In some configurations, the WWAN component 1022 is configured to provide dual-multi-mode connectivity to the network 102. For example, the WWAN component 1022 can be configured to provide connectivity to the network 102, wherein the network 102 provides service via GSM and UMTS technologies, or via some other combination of technologies. Alternatively, multiple WWAN components 1022 can be utilized to perform such functionality, and/or provide additional functionality to support other non-compatible technologies (i.e., incapable of being supported by a single WWAN component). The WWAN component 1022 can facilitate similar connectivity to multiple networks (e.g., a UMTS network and an LTE network).

The network 102 can be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 1024 is configured to connect to the network 102 via the WI-FI access points. Such connections can be secured via various encryption technologies including, but not limited, WI-FI Protected Access (“WPA”), WPA2, Wired Equivalent Privacy (“WEP”), and the like.

The network 102 can be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 1026 is configured to facilitate communications with other devices, such as peripherals, computers, or other computing entities via the WPAN.

The sensor components 1008 include a magnetometer 1028, an ambient light sensor 1030, a proximity sensor 1032, an accelerometer 1034, a gyroscope 1036, and a Global Positioning System sensor (“GPS sensor”) 1038. It is contemplated that other sensors, such as, but not limited to, temperature sensors or shock detection sensors, also can be incorporated in the computing device architecture 1000.

The magnetometer 1028 is configured to measure the strength and direction of a magnetic field. In some configurations the magnetometer 1028 provides measurements to a compass application program stored within one of the memory components 1004 in order to provide a user with accurate directions in a frame of reference including the cardinal directions, north, south, east, and west. Similar measurements can be provided to a navigation application program that includes a compass component. Other uses of measurements obtained by the magnetometer 1028 are contemplated.

The ambient light sensor 1030 is configured to measure ambient light. In some configurations, the ambient light sensor 1030 provides measurements to an application program stored within one the memory components 1004 in order to automatically adjust the brightness of a display (described below) to compensate for low-light and high-light environments. Other uses of measurements obtained by the ambient light sensor 1030 are contemplated.

The proximity sensor 1032 is configured to detect the presence of an object or thing in proximity to the computing device without direct contact. In some configurations, the proximity sensor 1032 detects the presence of a user's body (e.g., the user's face) and provides this information to an application program stored within one of the memory components 1004 that utilizes the proximity information to enable or disable some functionality of the computing device. For example, a telephone application program can automatically disable a touchscreen (described below) in response to receiving the proximity information so that the user's face does not inadvertently end a call or enable/disable other functionality within the telephone application program during the call. Other uses of proximity as detected by the proximity sensor 1028 are contemplated.

The accelerometer 1034 is configured to measure proper acceleration. In some configurations, output from the accelerometer 1034 is used by an application program as an input mechanism to control some functionality of the application program. For example, the application program can be a video game in which a character, a portion thereof, or an object is moved or otherwise manipulated in response to input received via the accelerometer 1034. In some configurations, output from the accelerometer 1034 is provided to an application program for use in switching between landscape and portrait modes, calculating coordinate acceleration, or detecting a fall. Other uses of the accelerometer 1034 are contemplated.

The gyroscope 1036 is configured to measure and maintain orientation. In some configurations, output from the gyroscope 1036 is used by an application program as an input mechanism to control some functionality of the application program. For example, the gyroscope 1036 can be used for accurate recognition of movement within a 3D environment of a video game application or some other application. In some configurations, an application program utilizes output from the gyroscope 1036 and the accelerometer 1034 to enhance control of some functionality of the application program. Other uses of the gyroscope 1036 are contemplated.

The GPS sensor 1038 is configured to receive signals from GPS satellites for use in calculating a location. The location calculated by the GPS sensor 1038 can be used by any application program that requires or benefits from location information. For example, the location calculated by the GPS sensor 1038 can be used with a navigation application program to provide directions from the location to a destination or directions from the destination to the location. Moreover, the GPS sensor 1038 can be used to provide location information to an external location-based service, such as E911 service. The GPS sensor 1038 can obtain location information generated via WI-FI, WIMAX, and/or cellular triangulation techniques utilizing one or more of the network connectivity components 1006 to aid the GPS sensor 1038 in obtaining a location fix. The GPS sensor 1038 can also be used in Assisted GPS (“A-GPS”) systems.

The I/O components 1010 include a display 1040, a touchscreen 1042, a data I/O interface component (“data I/O”) 1044, an audio I/O interface component (“audio I/O”) 1046, a video I/O interface component (“video I/O”) 1048, and a camera 1050. In some configurations, the display 1040 and the touchscreen 1042 are combined. In some configurations two or more of the data I/O component 1044, the audio I/O component 1046, and the video I/O component 1048 are combined. The I/O components 1010 can include discrete processors configured to support the various interface described below, or can include processing functionality built-in to the processor 1002.

The display 1040 is an output device configured to present information in a visual form. In particular, the display 1040 can present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 1040 is a liquid crystal display (“LCD”) utilizing any active or passive matrix technology and any backlighting technology (if used). In some configurations, the display 1040 is an organic light emitting diode (“OLED”) display. Other display types are contemplated.

The touchscreen 1042, also referred to herein as a “touch-enabled screen,” is an input device configured to detect the presence and location of a touch. The touchscreen 1042 can be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or can utilize any other touchscreen technology. In some configurations, the touchscreen 1042 is incorporated on top of the display 1040 as a transparent layer to enable a user to use one or more touches to interact with objects or other information presented on the display 1040. In other configurations, the touchscreen 1042 is a touch pad incorporated on a surface of the computing device that does not include the display 1040. For example, the computing device can have a touchscreen incorporated on top of the display 1040 and a touch pad on a surface opposite the display 1040.

In some configurations, the touchscreen 1042 is a single-touch touchscreen. In other configurations, the touchscreen 1042 is a multi-touch touchscreen. In some configurations, the touchscreen 1042 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures can be implemented in software for use with the touchscreen 1042. As such, a developer can create gestures that are specific to a particular application program.

In some configurations, the touchscreen 1042 supports a tap gesture in which a user taps the touchscreen 1042 once on an item presented on the display 1040. The tap gesture can be used for various reasons including, but not limited to, opening or launching whatever the user taps. In some configurations, the touchscreen 1042 supports a double tap gesture in which a user taps the touchscreen 1042 twice on an item presented on the display 1040. The double tap gesture can be used for various reasons including, but not limited to, zooming in or zooming out in stages. In some configurations, the touchscreen 1042 supports a tap and hold gesture in which a user taps the touchscreen 1042 and maintains contact for at least a pre-defined time. The tap and hold gesture can be used for various reasons including, but not limited to, opening a context-specific menu.

In some configurations, the touchscreen 1042 supports a pan gesture in which a user places a finger on the touchscreen 1042 and maintains contact with the touchscreen 1042 while moving the finger on the touchscreen 1042. The pan gesture can be used for various reasons including, but not limited to, moving through screens, images, or menus at a controlled rate. Multiple finger pan gestures are also contemplated. In some configurations, the touchscreen 1042 supports a flick gesture in which a user swipes a finger in the direction the user wants the screen to move. The flick gesture can be used for various reasons including, but not limited to, scrolling horizontally or vertically through menus or pages. In some configurations, the touchscreen 1042 supports a pinch and stretch gesture in which a user makes a pinching motion with two fingers (e.g., thumb and forefinger) on the touchscreen 1042 or moves the two fingers apart. The pinch and stretch gesture can be used for various reasons including, but not limited to, zooming gradually in or out of a website, map, or picture.

Although the above gestures have been described with reference to the use one or more fingers for performing the gestures, other appendages such as toes or objects such as styluses can be used to interact with the touchscreen 1042. As such, the above gestures should be understood as being illustrative and should not be construed as being limiting in any way.

The data I/O interface component 1044 is configured to facilitate input of data to the computing device and output of data from the computing device. In some configurations, the data I/O interface component 1044 includes a connector configured to provide wired connectivity between the computing device and a computer system, for example, for synchronization operation purposes. The connector can be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 1046 is configured to provide audio input and/or output capabilities to the computing device. In some configurations, the audio I/O interface component 1046 includes a microphone configured to collect audio signals. In some configurations, the audio I/O interface component 1046 includes a headphone jack configured to provide connectivity for headphones or other external speakers. In some configurations, the audio I/O interface component 1046 includes a speaker for the output of audio signals. In some configurations, the audio I/O interface component 1046 includes an optical audio cable out.

The video I/O interface component 1048 is configured to provide video input and/or output capabilities to the computing device. In some configurations, the video I/O interface component 1048 includes a video connector configured to receive video as input from another device (e.g., a video media player such as a DVD or BLURAY player) or send video as output to another device (e.g., a monitor, a television, or some other external display). In some configurations, the video I/O interface component 1048 includes a High-Definition Multimedia Interface (“HDMI”), mini-HDMI, micro-HDMI, DisplayPort, or proprietary connector to input/output video content. In some configurations, the video I/O interface component 1048 or portions thereof is combined with the audio I/O interface component 1046 or portions thereof.

The camera 1050 can be configured to capture still images and/or video. The camera 1050 can utilize a charge coupled device (“CCD”) or a complementary metal oxide semiconductor (“CMOS”) image sensor to capture images. In some configurations, the camera 1050 includes a flash to aid in taking pictures in low-light environments. Settings for the camera 1050 can be implemented as hardware or software buttons.

Although not illustrated, one or more hardware buttons can also be included in the computing device architecture 1000. The hardware buttons can be used for controlling some operational aspect of the computing device. The hardware buttons can be dedicated buttons or multi-use buttons. The hardware buttons can be mechanical or sensor-based.

The illustrated power components 1012 include one or more batteries 1052, which can be connected to a battery gauge 1054. The batteries 1052 can be rechargeable or disposable. Rechargeable battery types include, but are not limited to, lithium polymer, lithium ion, nickel cadmium, and nickel metal hydride. Each of the batteries 1052 can be made of one or more cells.

The battery gauge 1054 can be configured to measure battery parameters such as current, voltage, and temperature. In some configurations, the battery gauge 1054 is configured to measure the effect of a battery's discharge rate, temperature, age and other factors to predict remaining life within a certain percentage of error. In some configurations, the battery gauge 1054 provides measurements to an application program that is configured to utilize the measurements to present useful power management data to a user. Power management data can include one or more of a percentage of battery used, a percentage of battery remaining, a battery condition, a remaining time, a remaining capacity (e.g., in watt hours), a current draw, and a voltage.

The power components 1012 can also include a power connector, which can be combined with one or more of the aforementioned I/O components 1010. The power components 1012 can interface with an external power system or charging equipment via a power I/O component.

The disclosure presented herein can be considered in view of the following clauses.

A. A computing device, comprising: a processor; a computer-readable storage medium in communication with the processor, the computer-readable storage medium having computer-executable instructions stored thereupon which, when executed by the processor, cause the computing device to: receive a request associated with at least one of a product or a service; determine contextual data associated with the request, the contextual data defining a status of an application associated with the product or the service; based at least in part on the contextual data, determine, from data defining a plurality of support providers, one or more support providers of the plurality of support providers for supporting the request; generate task data associated with the request, the task data including the contextual data; send the task data to devices corresponding to the one or more support providers; receive acknowledgement data indicating an acknowledgement of the task data from a device of the devices corresponding to an individual support provider of the one or more support providers; determine that the individual support provider accepts the request based at least in part on the acknowledgement data; and cause a display of a graphical element indicating the acknowledgement of the task data.

B. The computing device as paragraph A recites, wherein the contextual data defines a status of a web browser application.

C. The computing device as paragraph B recites, wherein the contextual data further defines a status of a web page displayed on the web browser application.

D. The computing device as paragraph B recites, wherein the contextual data further defines a browser history associated with web pages previously visited via the web browser application.

E. The computing device as paragraph D recites, wherein the contextual data further defines a frequency associated with individual of the web pages visited in the browser history.

F. The computing device as any of paragraphs A-E recite, wherein the contextual data defines a status of a wizard application.

G. The computing device as paragraph F recites, wherein the contextual data further defines a status of a current step of the wizard application.

H. The computing device as paragraph F recites, wherein the contextual data further defines a status of steps of the wizard application previously completed by the device corresponding to the user.

I. The computing device as any of paragraphs A-H recite, wherein the contextual data defines a status of an interface of the application.

J. The computing device as paragraph I recites, wherein the contextual data further defines a status of a region of the interface of the application.

K. The computing device as any of paragraphs A-J recite, wherein the contextual data defines a status of a mail services application or a messaging services application.

L. The computing device as paragraph K recites, wherein the contextual data further defines a subject of an electronic communication received via the mail services application or the messaging services application.

M. The computing device as any of paragraphs A-L recite, wherein the contextual data defines a status of a social networking services application.

N. The computing device as any of paragraphs A-M recite, having computer-executable instructions stored thereupon that cause the computing device to provide an interface configured to receive at least one of data associated with the request, the contextual data, the acknowledgement data, or feedback data, wherein the interface is configured to transmit at least one of the task data including the contextual data or performance data.

O. A computer-implemented method, comprising computer-implemented operations for: receiving a request associated with at least one of a product or a service; determining contextual data associated with the request, the contextual data defining a status of an application associated with the product or the service; determining, from data associated with a plurality of support providers, one or more support providers for supporting the request based at least in part on the contextual data; generating task data associated with the request, the task data including the contextual data; sending the task data to devices corresponding to the one or more support providers; receiving acknowledgement data indicating an acknowledgement of the task data from a device of the devices corresponding to an individual support provider of the one or more support providers; determining that the individual support provider accepts the request; and causing a display of a first graphical element indicating at least one of the acknowledgement of the task data and a mechanism for creating a shared meeting space.

P. The computer-implemented method as paragraph O recites, comprising computer-implemented operations for: causing a display of a second graphical element comprising a control configured to provide functionality to generate the request in response to an actuation of the control; and receiving the request based at least in part on receiving data indicating that the control was actuated.

Q. The computer-implemented method as paragraph P recites, comprising computer-implemented operations for: determining, based on the data associated with the plurality of support providers, a number of support providers in the plurality of support providers that are signed into profiles corresponding to the support providers; determining that the number meets or exceeds a threshold value; and based at least in part on determining that the number meets or exceeds the threshold value, causing the display of the second graphical element.

R. The computer-implemented method as any of paragraphs O-Q recite, comprising computer-implemented operations for: causing a second graphical element corresponding to the task data to be presented on a display of each of the devices corresponding to the individual support providers; and causing the second graphical element corresponding to the task data to be presented in graphical representations of task lists personalized for each of the individual support providers.

S. The computer-implemented method as any of paragraphs O-R recite, wherein determining the one or more support providers for supporting the request comprises: accessing the data associated with the plurality of support providers, the data defining at least one of an authorization associated with individual support providers the plurality of support providers, an availability associated with the individual support providers, an expertise associated with the individual support providers, a rating associated with the individual support providers, a language of the individual support providers, a geographic location of the individual support providers, a quota of requests associated with the individual support providers, or a compensation structure associated with the individual support providers; determining a correlation between the contextual data and the data associated with the plurality of support providers; and determining the one or more support providers based at least in part on determining the correlation between the contextual data and the data associated with the plurality of support providers.

T. One or more computer-readable media encoded with instructions that, when executed by a processor, configure a computer to perform a method as any of paragraphs O-S recite.

U. A device comprising one or more processors and one or more computer readable media encoded with instructions that, when executed by the one or more processors, configure a computer to perform a computer-implemented method as any of paragraphs O-S recite.

V. One or more computer storage media having computer-executable instructions that, when executed by one or more processors, configure the one or more processors to perform operations comprising: receiving a request associated with a product or a service; determining contextual data associated with the request, the contextual data defining a status of an application associated with the product or the service; accessing data associated with a plurality of support providers associated with remote devices, the data associated with the plurality of support providers defining at least one of an authorization associated with individual support providers the plurality of support providers, an availability associated with the individual support providers, or an expertise associated with the individual support providers; causing a selection of one or more support providers of the plurality of support providers based at least in part on a correlation between the contextual data and the data associated with the plurality of support providers; sending a communication of the request comprising the contextual data to remote devices associated with the one or more support providers; receiving acknowledgement data indicating acknowledgement of the communication from a remote device of the remote devices corresponding to an individual support provider of the one or more support providers; determining that the individual support provider accepts the request based at least in part on the acknowledgment data; and generating a notification indicating the acknowledgement of the communication, wherein the notification comprises a display of a graphical element, an audio signal, a message, or a status change of at least one component of a computing device.

Based on the foregoing, it should be appreciated that technologies have been disclosed herein that enable real-time support for requests 116 based at least in part on contextual data 127. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes can be made to the subject matter described herein without following the example configurations and applications illustrated and described, and without departing from the true spirit and scope of the present invention, which is set forth in the following claims.

What is claimed is:

1. A computing device, comprising:
a processor;
a computer-readable storage medium in communication with the processor, the computer-readable storage medium having computer-executable instructions stored thereupon which, when executed by the processor, cause the computing device to:
receive a request associated with at least one of a product or a service;
determine contextual data associated with the request, the contextual data defining a status of an application associated with the product or the service;
based at least in part on the contextual data, determine, from data defining a plurality of support providers, one or more support providers of the plurality of support providers for supporting the request;
generate task data associated with the request, the task data including the contextual data;
send the task data to devices corresponding to the one or more support providers;
receive acknowledgement data indicating an acknowledgement of the task data from a device of the devices corresponding to an individual support provider of the one or more support providers;
determine that the individual support provider accepts the request based at least in part on the acknowledgement data; and
cause a display of a graphical element indicating the acknowledgement of the task data.

2. The computing device as claim 1 recites, wherein the contextual data defines a status of a web browser application.

3. The computing device as claim 2 recites, wherein the contextual data further defines a status of a web page displayed on the web browser application.

4. The computing device as claim 2 recites, wherein the contextual data further defines a browser history associated with web pages previously visited via the web browser application.

5. The computing device as claim 4 recites, wherein the contextual data further defines a frequency associated with individual of the web pages visited in the browser history.

6. The computing device as claim 1 recites, wherein the contextual data defines a status of a wizard application.

7. The computing device as claim 6 recites, wherein the contextual data further defines a status of a current step of the wizard application.

8. The computing device as claim 6 recites, wherein the contextual data further defines a status of steps of the wizard application previously completed by the device corresponding to the user.

9. The computing device as claim 1 recites, wherein the contextual data defines a status of an interface of the application.

10. The computing device as claim 9 recites, wherein the contextual data further defines a status of a region of the interface of the application.

11. The computing device as claim 1 recites, wherein the contextual data defines a status of a mail services application or a messaging services application.

12. The computing device as claim 11 recites, wherein the contextual data further defines a subject of an electronic communication received via the mail services application or the messaging services application.

13. The computing device as claim 1 recites, wherein the contextual data defines a status of a social networking services application.

14. The computing device as claim 1 recites, having computer-executable instructions stored thereupon that cause the computing device to provide an interface configured to receive at least one of data associated with the request, the contextual data, or the acknowledgement data, wherein the interface is configured to transmit at least the task data including the contextual data.

15. A computer-implemented method, comprising computer-implemented operations for:
receiving a request associated with at least one of a product or a service;
determining contextual data associated with the request, the contextual data defining a status of an application associated with the product or the service;
determining, from data associated with a plurality of support providers, one or more support providers for supporting the request based at least in part on the contextual data;
generating task data associated with the request, the task data including the contextual data;
sending the task data to devices corresponding to the one or more support providers;
receiving acknowledgement data indicating an acknowledgement of the task data from a device of the devices corresponding to an individual support provider of the one or more support providers;
determining that the individual support provider accepts the request; and
causing a display of a first graphical element indicating at least one of the acknowledgement of the task data and a mechanism for creating a shared meeting space.

16. The computer-implemented method as claim 15 recites, comprising computer-implemented operations for:
causing a display of a second graphical element comprising a control configured to provide functionality to generate the request in response to an actuation of the control; and
receiving the request based at least in part on receiving data indicating that the control was actuated.

17. The computer-implemented method as claim 16 recites, comprising computer-implemented operations for:
determining, based on the data associated with the plurality of support providers, a number of support providers in the plurality of support providers that are signed into profiles corresponding to the support providers;
determining that the number meets or exceeds a threshold value; and
based at least in part on determining that the number meets or exceeds the threshold value, causing the display of the second graphical element.

18. The computer-implemented method as claim 15 recites, comprising computer-implemented operations for:
causing a second graphical element corresponding to the task data to be presented on a display of each of the devices corresponding to the individual support providers; and
causing the second graphical element corresponding to the task data to be presented in graphical representations of task lists personalized for each of the individual support providers.

19. The computer-implemented method as claim 15 recites, wherein determining the one or more support providers for supporting the request comprises:
accessing the data associated with the plurality of support providers, the data defining at least one of an authorization associated with individual support providers the plurality of support providers, an availability associated with the individual support providers, an expertise associated with the individual support providers, a rating associated with the individual support providers, a language of the individual support providers, a geographic location of the individual support providers, a quota of requests associated with the individual support providers, or a compensation structure associated with the individual support providers;
determining a correlation between the contextual data and the data associated with the plurality of support providers; and
determining the one or more support providers based at least in part on determining the correlation between the contextual data and the data associated with the plurality of support providers.

20. One or more computer storage media having computer-executable instructions that, when executed by one or more processors, configure the one or more processors to perform operations comprising:
receiving a request associated with a product or a service;
determining contextual data associated with the request, the contextual data defining a status of an application associated with the product or the service;
accessing data associated with a plurality of support providers associated with remote devices, the data associated with the plurality of support providers defining at least one of an authorization associated with individual support providers the plurality of support providers, an availability associated with the individual support providers, or an expertise associated with the individual support providers;
causing a selection of one or more support providers of the plurality of support providers based at least in part on a correlation between the contextual data and the data associated with the plurality of support providers;
sending a communication of the request comprising the contextual data to remote devices associated with the one or more support providers;
receiving acknowledgement data indicating acknowledgement of the communication from a remote device of the remote devices corresponding to an individual support provider of the one or more support providers;
determining that the individual support provider accepts the request based at least in part on the acknowledgment data; and
generating a notification indicating the acknowledgement of the communication, wherein the notification comprises a display of a graphical element, an audio signal, a message, or a status change of at least one component of a computing device.
